(19) United States
(12) Patent Application Publication
(10) Pub. No.: US 2011/0287992 A1
(43) Pub. Date: Nov. 24, 2011

(54) MULTIFUNCTIONAL MULTIPLE GRAFT MONOMER LOW MOLECULAR WEIGHT POLYMER

(75) Inventors: Irwin L. Goldblatt, Edison, NJ (US); Richard P. Sauer, North Plainfield, NJ (US); Shean-jer Chen, Bridgewater, NJ (US)

(73) Assignee: Castrol Limited, Warrenville, IL (US)

(21) Appl. No.: 12/947,434

(22) Filed: Nov. 16, 2010

Related U.S. Application Data
(60) Provisional application No. 61/261,914, filed on Nov. 17, 2009.

(51) Int. Cl. C10M 169/04; C08F 8/32; C08F 265/04; C08F 226/06; C08F 226/10; C10L 1/22; C08F 8/14; C08F 2/06; C08F 257/02; C08F 255/10; C08F 279/02; C08F 255/02; C08F 8/08; C08F 220/54

(52) U.S. Cl. 508/545; 525/112; 525/293; 525/298; 525/308; 525/279; 525/281; 525/283; 525/296; 525/287; 525/291; 525/301; 525/242; 525/244; 525/251; 525/254; 525/255; 44/412

(57) ABSTRACT

The composition and preparation of multiple graft low molecular weight polymers useful as dispersants are described. The dispersants described are suitable for controlling sludge and varnish as well as soot. The product is useful as a lubricant additive and a fuel additive.

This application claims the benefit of U.S. Provisional Patent Application 61/261,914 filed on Nov. 17, 2009, and which is incorporated by reference herein in its entirety.

### FIELD OF THE INVENTION

The present invention relates to a novel multiple function graft polymer with a polymer backbone, where the polymer backbone has a weight average molecular weight of from about 500 to about 9950. The polymer backbone is grafted with monomers associated with sludge control, varnish control, and with monomers associated with soot control and thereby viscosity control associated with soot control, to thereby provide a graft polymer exhibiting multiple performance functions. The present invention also relates to a lubricating oil composition containing such novel multiple-function graft polymer, and a fuel containing such novel multiple-function graft polymer as a fuel additive, and a method for manufacturing such novel multiple-function graft polymer.

### BACKGROUND OF THE INVENTION

Lubricating oil compositions used to lubricate internal combustion engines contain a base oil of lubricating viscosity, or a mixture of such oils, and additives used to improve the performance characteristics of the oil. For example, additives are used to improve detergency and dispersancy, to reduce engine wear, to provide stability against heat and oxidation, to reduce oil consumption, to inhibit corrosion, to act as a dispersant, and to reduce friction loss, among other attributes. However, each such additive is a separate component of the formulated lubricating oil and adds cost. Thus, it would be beneficial to have a multi-functional additive that controls more than one performance characteristic of the lubricating oil.

For example, U.S. Pat. No. 4,234,435, discloses carboxylic acid acylating agents derived from polyalkenes and a dibasic, carboxylic reactant such as maleic or fumaric acid or certain derivatives thereof. The acylating agents can be reacted with a further reactant subject to being acylated such as polyethylene polyamines and polyols to produce derivatives useful as lubricant additives.

U.S. Pat. No. 6,107,258 discloses functionalized olefin copolymers that provide dispersancy properties, comprising acylated olefin copolymers containing reactive carboxylic functionality. The acylated polymer is reacted with a coupling compound which contains more than one amine, thiol and/or hydroxyl functionality capable of reacting with carboxylic functionality.

Goldblatt et al., U.S. Pat. No. 6,410,652 issued Jun. 25, 2002, discloses a graft copolymer which is useful as a dispersant viscosity index improver and a method for making the graft copolymer. The disclosed method comprises the steps of (a) providing a graftable polymer or copolymer having a weight average molecule weight of from about 20,000 to about 500,000, an ethylenically unsaturated sulfur-, nitrogen- and/or oxygen-containing graftable monomer, and an amount of an initiator that is sufficient to graft such monomer and graftable copolymer or polymer; (b) introducing the aforesaid graftable copolymer or polymer into a melt-blending apparatus; (c) introducing the aforesaid graftable monomer into the melt-blending apparatus, (d) introducing the aforesaid initiator into the melt-blending apparatus, wherein at least one of the aforesaid graftable copolymer or polymer, graftable monomer and initiator is introduced into the melt-blending apparatus in the presence of at least either a polar or non-polar solvent; and (e) reacting the aforesaid graftable copolymer or polymer, monomer and initiator by operating the melt-blending apparatus, thereby forming the aforesaid graft copolymer as the product. The aforesaid Goldblatt et al. U.S. Pat. No. 6,410,652 also discloses a lubricating oil composition comprising a base oil and an aforesaid graft copolymer.

Goldblatt et al., U.S. Pat. No. 7,371,713, issued on May 13, 2008, discloses graftable monomers that are formed as the product of the reaction between an amine and an acylating agent. The reaction product is a graftable ethylenically unsaturated, aliphatic or aromatic monomer having nitrogen and oxygen atoms. This graftable monomer is then grafted onto a polyolefin backbone having a weight average molecular weight of from about 10,000 to about 750,000 to form a graft copolymer that has dispersant viscosity index improving properties. More particularly, the aforesaid polyolefin backbone is dissolved in a solvent, and the graftable monomer and an initiator are added to the resulting solution. In the alternative, a melt-blending procedure can be employed to graft the graftable monomer onto the aforesaid polyolefin. The aforesaid Goldblatt et al., U.S. Pat. No. 7,371,713 also discloses a lubricating oil composition comprising a hydrocarbon base oil and the aforesaid graft copolymer.

Goldblatt et al., U.S. patent application Ser. No. 11/912,847, published on Nov. 27, 2008 as Publication No. 2008/0293600A1, discloses a multifunctional grafted polymer containing two groups of monomers grafted to a polyolefin or polyester backbone where the backbone has a weight average molecular weight from about 10,000 to about 1,000,000, one group of monomers to impart dispersancy, viscosity index improvement and sludge and varnish control as well as another group of monomers to impart soot handling performance. Generally, one such group of monomers comprises ethylenically unsaturated, aliphatic or aromatic monomers having 2 to about 50 carbon atoms containing oxygen or nitrogen, or both oxygen and nitrogen and imparts dispersancy, viscosity index improvement and sludge and varnish control. Another such group of monomers, the acylating agent provides acyl groups for reaction, and reacts with amines to form substituents that are suitable for imparting soot handling performance. In general, such amines are comprised of primary and secondary amines that can undergo a condensation reaction with an appropriate acylating agent.

Goldblatt et al., U.S. patent application Ser. No. 11/912,847 also discloses a lubricating oil comprising a hydrocarbon base oil and a multifunctional grafted polymer described above. The multifunctional grafted polyolefin or polyester functions as a viscosity index improver as well as an additive to control viscosity, sludge, and varnish and soot. Such lubricating oils utilize both (a) the superior dispersancy and (b) the soot control properties of the disclosed multi-functional grafted polymers and thereby require lower amounts of the other additives or fewer additives.

Goldblatt et al., U.S. patent application Ser. No. 11/912,847 also discloses an effective method of making the aforesaid multi-functional graft polymer in which the grafting sequence is important in order to generate the multi-functional graft polymer described herein. In order to achieve good performance with respect to both soot handling and sludge and varnish control, it is important to first graft a graftable acylating agent, onto the polymer backbone to thereby form a polymer containing acyl groups. Next, the monomer or monomer grouping associated with sludge and varnish handling is introduced. Finally, the amine or amines capable of undergoing a reaction with the acyl group, is introduced and reacted with the acylated polymer thereby imparting soot handling performance to the graft polymer.

The inventors of the present invention have now discovered a novel multiple function graft low molecular weight polymer for lubricating oil compositions.

### SUMMARY OF THE INVENTION

The present invention is a multiple function low molecular weight polymer comprising a graftable polymer that suitably has a weight average molecular weight of about 500 to about 9950, or to about 9500, and a graftable ethylenically unsaturated, aliphatic or aromatic monomer having 2 to, for example, about 50 carbon atoms and containing at least one of nitrogen and oxygen, and, a second monomer that is the condensation product of a graftable coupling group and an amine, wherein the graftable coupling group can be selected from the group consisting of acylating agents and epoxides.

The ethylenically unsaturated, aliphatic or aromatic monomer can impart dispersancy and viscosity sludge and varnish control. The second monomer, that is the condensation product of the graftable coupling agent and the amine, can impart soot control properties.

A suitable coupling agent is selected from the group consisting of acylating agents and epoxides, has at least two component coupling sites, at least one of which is a site of olefinic unsaturation, and reacts with the polymer to afford a coupling group, such as an acyl group, on the backbone of the polymer. The coupling agent is typically an acylating agent selected from the group consisting of monocarboxylic acids, dicarboxylic acids, polycarboxylic acids, the anhydrides of such acids, the lower alkyl esters of such acids, the halides of such acids, and combinations thereof, or an epoxide. The amine that that undergoes a condensation reaction with the aforesaid graftable coupling group is selected from the group of primary and secondary amines.

The present invention also discloses a process which can be performed either in solution or by melt extrusion to make the aforesaid multiple function low molecular weight graft polymer of this invention. The solution phase process comprises the steps of providing an aforesaid graftable polymer, an initiator, an aforesaid ethylenically unsaturated, aliphatic or aromatic graftable monomer, an aforesaid graftable coupling group, and an aforesaid amine. First, the aforesaid graftable polymer is suitably dissolved in a solvent. A specific grafting sequence is preferred in order to generate the multi-functional graft polymer of this invention. To achieve good performance with respect to both soot handling as well as sludge and varnish control, it is advantageous to graft, such as by using an appropriate initiator, the aforesaid coupling agent onto the graftable polymer to form a polymer containing coupling groups on the backbone. Next, the aforesaid ethylenically unsaturated graftable monomer containing at least one of nitrogen and oxygen, and an initiator are introduced, and the ethylenically unsaturated monomer is grafted to the graftable polymer backbone. Finally the amine or amines capable of undergoing a reaction with the graftable coupling groups are introduced and reacted with the coupling group on the polymer backbone.

The melt process comprises the steps of providing an aforesaid graftable polymer, an aforesaid initiator, an aforesaid graftable ethylenically unsaturated, aliphatic or aromatic monomer, an aforesaid graftable coupling agent, and an aforesaid amine capable of undergoing reaction with coupling groups formed by reaction of the aforesaid polymer and coupling agent. First, the aforesaid graftable low molecular weight polymer is fed as a solid, a semi-solid or as a neat liquid to the extruder, blender or mixer and maintained under the desired reaction conditions. The aforesaid graftable ethylenically unsaturated monomer, graftable coupling agent, and initiator reactants are introduced either together with the low molecular weight graftable polymer or, separately, such as subsequently, to the low molecular weight graftable polymer. If introduced separately from the polymer, the reactants may be introduced either together or separately. After the reaction of the graftable low molecular weight polymer with the graftable monomer and the graftable coupling agent, the aforesaid amine capable of reacting with the coupling groups either is fed to the extruder, blender or mixer where it reacts with the coupling groups. Alternatively it may be introduced to a solution of the graft polymer that had been produced in the extruder, blender or mixer and reacted with the graft polymer in solution.

The present invention is also a lubricating oil composition comprising a lubricant base oil containing at least about 0.05 weight percent of the multiple function polymer of this invention; and from 0 to about, for example, 20 weight percent of other dispersants.

The present invention is also a fuel composition that comprises a major proportion of a hydrocarbon based fuel and, for example, about 5 to about 5,000 parts per million by weight of the multifunctional low molecular weight graft polymer of the present invention and optionally other components such as alcohols and ethers.

### DETAILED DESCRIPTION OF THE INVENTION

While the invention will be described in connection with one or more preferred embodiments and certain illustrative examples, it will be understood that the invention is not limited to those embodiments and examples. The invention includes all alternatives, modifications and equivalents as may be included within the spirit and scope of the appended claims.

One embodiment of the invention relates to a multifunctional multiple-graft monomer low molecular weight graft polymer comprising:
a. at least one low molecular weight polymer backbone having graftable sites;
b. at least one graftable coupling agent having at least two component coupling sites, for example, at least one of which is a site of olefinic unsaturation, and the other is selected from the group consisting of acylating agents and epoxides;
c. at least one graftable ethylenically unsaturated, aliphatic or aromatic monomer having from 2 to, for example, about 50 carbon atoms and containing at least one of nitrogen and oxygen; and
d. at least one amine capable of reacting with the coupling group on the low molecular weight polymer backbone that is formed by reaction between the aforesaid graftable coupling agent and polymer.
   In the multifunctional multiple-graft monomer low molecular weight graft polymer of the present invention, the aforesaid graftable polymer backbone may be selected from the group consisting of low molecular weight polyolefins, low molecular weight polyesters, modified polyesters, styrene containing polymers and combinations thereof.

Another embodiment of the present invention relates to a lubricating oil comprising:
(a) a lubricant base oil;
(b) a multifunctional multiple-graft monomer low molecular weight graft polymer of the present invention; and, optionally,
(c) other lubricating oil additives.

A further embodiment of the present invention relates to a fuel composition comprising:
(a) a hydrocarbon fuel
(b) a multifunctional multiple-graft low molecular weight graft polymer of the present invention; and optionally
(c) other components such as alcohols and ethers.

Another embodiment of the present invention relates to a method of improving soot handling and sludge and varnish control of a lubricating oil which comprises incorporating into said oil an effective amount of the multiple function dispersant polymer of the present invention.

Another embodiment of the present invention relates to a method of making a multifunctional multiple-graft monomer low molecular weight graft polymer comprising the steps of:
(a) reacting a low molecular weight polymer having graftable sites with a coupling agent selected from the group consisting of acylating agents and epoxides and having at least two component coupling sites, at least one of which is a site of olefinic unsaturation, in the presence of an initiator, to form a graft polymer reaction product of the coupling agent and polymer backbone;
(b) reacting the low molecular weight graft polymer reaction product formed in step (a) with an ethylenically unsaturated, aliphatic or aromatic monomer having from 2 to, for example, about 50 carbon atoms and containing at least one of nitrogen and oxygen, in the presence of an initiator, to form a low molecular weight graft polymer reaction product of the aforesaid ethylenically unsaturated monomer, the coupling group, and the polymer backbone having coupling groups available for reaction; and
(c) reacting the low molecular weight graft polymer reaction product formed in step (b) with an amine capable of reacting with the coupling groups to form a multifunctional multiple-graft monomer low molecular weight graft polymer.

The novel multifunctional multiple-graft monomer low molecular weight graft polymer according to the present invention can be prepared using the reactants either neat, dissolved in a suitable solvent, or neat in a melt state. In general, the graftable low molecular weight polymer is reacted with a coupling agent in the presence of an initiator. The low molecular weight graft polymer containing the coupling group thus formed is then reacted in the presence of an initiator with one or more aforesaid graftable monomers that contain at least one of nitrogen and oxygen that are preferably capable of imparting sludge and varnish handling properties. Finally, one or more amines that preferably are suitable for imparting soot handling performance are reacted with the coupling groups on the polymer backbone to provide the multifunctional multiple-graft monomer low molecular weight graft polymer of the present invention.

In preparing the multifunctional multiple-graft monomer low molecular weight graft polymer of the present invention as described above, more than one low molecular weight polyolefin or low molecular weight polyester or mixtures of one or more polyolefins and/or polyesters and or other suitable polymers can be used. More than one aforesaid coupling agent, monomer capable of imparting sludge and varnish handling properties, initiator, and/or amine, can be used as well.

### Reaction Materials

The following are examples of the aforesaid graftable low molecular weight polymers, graftable coupling agents, graftable ethylenically unsaturated monomers, and the amines that are capable of undergoing reaction with the grafted coupling agents to yield the final products useful for controlling sludge, varnish, viscosity and soot.

### Low Molecular Weight Polymers

A wide variety of polyolefins, modified polyolefins, polyesters, and modified polyesters (which may or may not have pendant unsaturation) are contemplated for use as suitable polymer backbones for grafting in the present invention. The materials contemplated include homopolymers, copolymers, terpolymers and higher, such as, but not limited to, low molecular weight polymers generated from ethylene, propylene, isoprene, butene, butadiene, isobutylene, methyl methacrylate and methyl acrylate, styrene and combinations thereof. Examples of such low molecular weight polyolefins and low molecular weight polyesters include low molecular weight polymers containing one or more monomers, such as polyisobutylene, polymethacrylates, polyacrylates, polyalkylstyrenes, partially hydrogenated low molecular weight polyolefins of butadiene and styrene and low molecular weight polymers of isoprene, as well as low molecular weight polymers of styrene and isoprene. The use of mixtures of polymers such as mixtures of polyolefins, mixtures of polyesters, and mixtures of polyolefins and polyesters for making the multifunctional low molecular weight graft polymer of the present invention is also contemplated. The use of mixtures of olefins and esters to make mixed olefin-ester polymers is also contemplated. The use of chemical and physical mixtures of polyolefins, mixtures of polyesters, and combinations thereof is also contemplated. The low molecular weight polymers contemplated herein may have weight average molecular weights suitably from about 500, alternatively from about 750, alternatively about 900, to about 9950, alternatively to about 9,500, alternatively to about 6,500, alternatively to about 5,000. The low molecular weight polymers suitably have polydispersities from about 1 to about 20, alternatively to about 10, alternatively to about 3.

Particular materials contemplated for use herein include low molecular weight polyisobutylene, such as those marketed by Ineos, low molecular weight olefin copolymers, such as those marketed by ExxonMobil Corp., and polyesters, such as those marketed by Evonik. Combinations of the above materials, and other, similar materials are also contemplated.

### Coupling Agents

An acylating agent that is suitable for use as a coupling agent in the present invention has at least two component coupling sites, at least one of which is a site of olefinic unsaturation in its structure. Usually, the point of olefinic unsaturation will correspond to —HC═CH— or —HC═CH₂. Acylating agents in which the point of olefinic unsaturation is α, β to a carboxy functional group are particularly useful. Olefinically unsaturated mono-, di-, and polycarboxylic acids, the lower alkyl esters thereof, the halides thereof, and the anhydrides thereof are typical acylating agents that are suitable for use in the present invention. Preferably, the olefinically unsaturated acylating agent employed in the present invention is a mono- or dibasic acid, or a derivative thereof such as an anhydride, lower alkyl ester, halide or mixture of two or more such derivatives. In this context “lower alkyl” means an alkyl group having from one to seven carbon atoms.

A suitable acylating agent may include at least one member selected from the group consisting of monounsaturated C₄ to C₅₀, alternatively C₄ to C₂₀, alternatively C₄ to C₁₀, dicarboxylic acids, monounsaturated C₃ to C₅₀, such as C₃ to C₂₀, or C₃ to C₁₀, monocarboxylic acids and anhydrides thereof (that is, anhydrides of those dicarboxylic acids or of those monocarboxylic acids), and combinations of any of the foregoing acids and/or anhydrides.

Suitable acylating agents include acrylic acid, crotonic acid, methacrylic acid, maleic acid, maleic anhydride, fumaric acid, itaconic acid, itaconic anhydride, citraconic acid, citraconic anhydride, mesaconic acid, glutaconic acid, chloromaleic acid, aconitic acid, methylcrotonic acid, sorbic acid, 3-hexenoic acid, 10-decenoic acid, 2-pentene-1,3,5-tricarboxylic acid, cinnamic acid, and lower alkyl (for example, C₁ to C₄ alkyl) acid esters of the foregoing, for example, methyl maleate, ethyl fumarate, and methyl fumarate. Particularly suitable acylating agents are the unsaturated dicarboxylic acids and their derivatives; especially maleic acid, fumaric acid and maleic anhydride.

An epoxy derivative that is useful as a coupling agent in the present invention has, in general, at least one point of olefinic unsaturation in its structure. Once the epoxide is grafted onto the polymer backbone, it may be reacted, for example, with an amine to form hydroxylamine. The grafted epoxide may also be reacted with other reagents such as alcohols, mercaptans and carboxylic acids. Suitable epoxides include glycidyl methacrylate, allyl glycidyl ether, and 1,2-epoxy-5-hexene and 3,4-epoxy-1-butene.

### Graftable Ethylenically Unsaturated Monomers

Ethylenically unsaturated monomers that are useful for imparting sludge and varnish control, are, very broadly, ethylenically unsaturated, aliphatic or aromatic monomers having from 2 to about 50 carbon atoms and containing at least one of nitrogen and oxygen. Combinations of such ethylenically-unsaturated monomers are also contemplated for use as graftable monomers in the present invention. Specific graftable monomers contemplated for use herein include the following: N-vinylimidazole (also known as 1-vinylimidazole) (VIMA), 1-vinyl-2-pyrrolidinone, C-vinylimidazole, N-allylimidazole, 1-vinylpyrrolidinone, 2-vinylpyridine, 4-vinylpyridine, N-methyl-N-vinylacetamide, diallyl formamide, N-methyl-N-allyl formamide, N-ethyl-N-allyl formamide, N-cyclohexyl-N-allyl formamide, N-allyl diisooctyl phenothiazine, 2-methyl-1-vinylimidazole, 3-methyl-1-vinylpyrazole, N-vinylpurine, N-vinylpiperazines, vinylpiperidines, vinylmorpholines, maleimides, acylamides, such as N,N-dimethyl acrylamide and N,N-dimethylaminopropyl acrylamide as well as combinations of these materials or other similar materials. Such graftable ethylenically unsaturated monomers for use in the present invention may contain, in addition to nitrogen and/or oxygen, other elements such as one or more of sulfur, phosphorus, or the halogens. Examples of suitable graftable monomers of this group are 4-methyl-5-vinylthiazole, N-allyl diisooctyl phenothiazine, 2-vinylthiobenzothiazole, 2-allylthiobenzothiazole, 2-butenylthiobenzothiazole, N-vinylphenothiazine and N-allylphenothiazine. Other graftable ethylenically unsaturated monomers suitable for use in the manufacture of the multifunctional multiple graft monomer low molecular weight polymer of this invention are disclosed in column 4, lines 4-41 of U.S. Pat. No. 4,146,489, column 3, lines 25-55 of U.S. Pat. No. 4,810,754, column 3, lines 27-47 of U.S. Pat. No. 4,092,255, the disclosures of which are incorporated herein by reference in their entirety.

Amines for Reaction with the Coupling Group

Amines suitable for imparting soot handling performance are those capable of undergoing a condensation reaction with the coupling group grafted onto the low molecular weight polymer, namely, primary and secondary amines.

One or more amines may be used. Amines capable of being acylated are disclosed in column 4, line 60 to column 6, line 14 of U.S. Pat. No. 4,320,019, the disclosure of which in its entirety is incorporated herein by reference; column 10, line 61 to column 13, line 18 of U.S. Pat. No. 5,424,367, the disclosure of which in its entirety is incorporated herein by reference; and in column 13, line 5 to column 17, line 32 of U.S. Pat. No. 5,427,702, the disclosure of which in its entirety is incorporated herein by reference. Among the various amine types that are useful in the practice of this invention are alkyl amines, alkylene amines, amines of molecules containing hetero-atoms or heterocycles, alkylene polyamines, aromatic amines, and polyoxyalkylene polyamines.

Some examples of the alkyl amines, alkylene amines, alkylene polyamines and amines of molecules containing heterocycles, include methyleneamines, ethyleneamines, butyleneamines, propyleneamines, pentyleneamines, hexyleneamines, heptyleneamines, octyleneamines, N,N-dimethyaminopropyl amine, N,N-dioctylethyl amine, other polymethyleneamines, the cyclic and higher homologs of these amines such as the piperazines, the amino-alkyl-substituted piperazines, such as (2-aminopropyl)-piperazine; 1,4-bis-(2-aminoethyl)piperazine, and 2-methyl-1-(2-aminobutyl)piperazine. Suitable polyaminic materials include ethylene diamine, diethylene triamine, triethylene tetramine, propylene diamine, di(heptamethylene)triamine, tripropylene tetramine, tetraethylene pentamine, trimethylene diamine, pentaethylene hexamine, di(trimethylene)triamine, and N-octyl-N′-methyethylene diamine. Other higher homologs obtained by condensing two or more of the above-mentioned alkyleneamines may also be used as well as heterocycles such as 3-morpholinopropylamine.

Other amine types useful in the practice of this invention include amino-aromatic compounds such as aryl amines and alkyl aryl amine and the N-arylphenylenediamines. Specific aromatic amines include, for example, aniline, 4-morpholine aniline, benzylamine, phenylethylamine, 3-phenyl-1-propylamine, and the N-phenylphenylenediamines, such as N-phenyl-1,4-phenylenediamine (also referred to as 4-aminodiphenylamine), N-phenyl-1,3-phenylenediamine, N-phenyl-1,2-phenylenediamine, N-naphthyl-phenylenediamine, N-phenylnaphthalenediamine and N′-aminopropyl-N-phenylphenylenediamine. Combinations of the above amines may be used to react with one or more coupling agent groups.

Examples of suitable polyoxyalkylene polyamines are those which have the formulae:

NH₂(-alkylene-O-alkylene)ₘNH₂ (i)

where m has a value of about 3 to 70 and suitably 10 to 35; and

R-(alkylene(-O-alkylene)ₙNH₂)₃₋₆ (ii)

where n has a value of 1 to 40, with the provision that the sum of all the n's is about 3 to about 70, and suitably from about 6 to about 35, and R is a polyvalent saturated hydrocarbon radical of up to 10 carbon atoms. The alkylene groups in either formula (i) or (ii) may be straight or branched chains containing about 2 to 7, and suitably about 2 to 4 carbon atoms.

The polyoxyalkylene polyamines, such as polyoxyalkylene diamines and polyoxyalkylene triamines, have average molecular weights ranging from about 200 to about 4000 and suitably from about 400 to about 2000. Suitable polyoxyalkylene polyamines include the polyoxyethylene and polyoxypropylene diamines and the polyoxypropylene triamines having average molecular weights ranging from about 200 to 2000.

Other amine types useful in the practice of this invention include amino-aromatic compounds such as:

N-arylphenylenediamines represented by the formula:

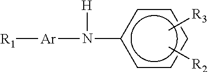

in which Ar is aromatic and R₁ is hydrogen or, —NH-aryl, —NH-arylalkyl, —NH-alkylaryl, or a branched or straight chain radical having from 4 to 24 carbon atoms and the radical can be an alkyl, alkenyl, alkoxyl, arylalkyl, alkylaryl, hydroxyalkyl or aminoalkyl radical, R₂ is —NH₂, —(NH(CH₂)ₙ—)ₘ—NH₂, CH₂—(CH₂)ₙ—NH₂, -aryl-NH₂, in which n and m each has a value from 1 to 10, and R₃ is hydrogen or an alkyl, alkenyl, alkoxyl, arylalkyl, or alkylaryl radical which may have from 4 to 24 carbon atoms. The N-arylphenylenediamine compounds may also be represented by the formula:

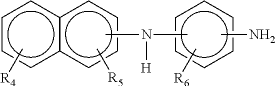

in which R₄, R₅ and R₆ are hydrogen or a linear or branched hydrocarbon radical containing from 1 to 10 carbon atoms and that radical may be an alkyl, alkenyl, alkoxyl, alkylaryl, arylalkyl, hydroxyalkyl, or aminoalkyl radical, and R₄, R₅ and R₆ can be the same or different;

Particularly suitable N-arylphenylenediamines are the N-phenylphenylenediamines, for example, N-phenyl-1,4-phenylenediamine (also referred to herein as 4-aminodiphenylamine), N-phenyl-1,3-phenylenediamine, N-phenyl-1,2-phenylenediamine, N-naphthyl-phenylenediamine, N-phenylnaphthalenediamine and N′-aminopropyl-N-phenylphenylenediamine. Most preferably, the amine is 4-aminodiphenylamine (also called N-phenyl-1,4-phenylenediamine).

Other useful amines include the amino-imidazolines such as 2-heptyl-3-(2-aminopropyl)imidazoline, 4-methylimidazoline and 1,3-bis-(2-aminoethyl)imidazoline, and the aminothiazoles such as aminothiazole, aminobenzothiazole, aminobenzothiadiazole and aminoalkylthiazole.

The aminocarbazoles, aminoindoles, amino-indazolinones, aminomercaptotriazole and aminoperimidines are also useful. Structures for these are presented below. The aminocarbazoles are represented by the formula:

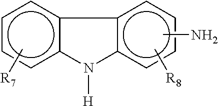

in which R₇ and R₈ represent hydrogen or an alkyl, alkenyl, or alkoxyl radical having from 1 to 14 carbon atoms, and R₇ and R₅ can be the same or different.

The aminoindoles are represented by the formula:

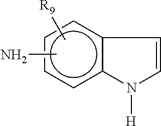

in which R₉ represents hydrogen or an alkyl radical having from 1 to 14 carbon atoms,

The amino-indazolinones are represented by the formula:

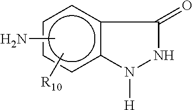

in which R₁₀ is hydrogen or an alkyl radical having from 1 to 14 carbon atoms.

The aminomercaptotriazole is represented by the formula:

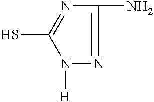

The aminoperimidines are those represented by the formula:

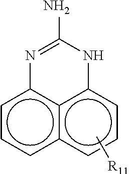

in which R₁₁ represents hydrogen or an alkyl or alkoxyl radical having from 1 to 14 carbon atoms.

Other useful amines include: 2-heptyl-3-(2-aminopropyl)imidazoline, 4-methylimidazoline, 1,3-bis-(2-aminoethyl)imidazoline, (2-aminopropyl)-piperazine, 1,4-bis-(2-aminoethyl)piperazine, N,N-dimethyaminopropyl amine, N,N-dioctylethyl amine, N-octyl-N′-methylethylene diamine, and 2-methyl-1-(2-aminobutyl)piperazine, and an aminothiazole from the group consisting of aminothiazole, aminobenzothiazole, aminobenzothiadiazole and aminoalkylthiazole.

It is also contemplated that combinations of the above amines may be used to react with one or more coupling agent groups.

The choice of amine compound will depend, in part, upon the nature of the coupling group. In the case of one preferred acylating agent, maleic anhydride, those amines that will react advantageously with the anhydride functionality are preferred. Primary amines are desirable because of the stability of the imide products formed.

Primary amines, structurally described as RNH₂, in which the R group may contain performance enhancing functionalities desirable for the final product may be used. Such enhancements may include, among others, wear protection, friction reduction and protection against oxidation. Incorporation of elements, in addition to carbon, hydrogen, oxygen and nitrogen, includes, but is not limited to the halogens, sulfur or phosphorus, either alone or in combination, is also contemplated.

### Free-Radical Initiators

Broadly, any free-radical initiator capable of operating under the conditions of the reactions between the aforesaid graftable low molecular weight polymer and the coupling agent can be used in the present invention. Representative initiators are disclosed in column 4, lines 45-53 of U.S. Pat. No. 4,146,489, the disclosure of which in its entirety is incorporated herein by reference. Specific “peroxy” initiators contemplated include alkyl, dialkyl, and aryl peroxides, for example: di-t-butyl peroxide (abbreviated herein as “DTBP”), dicumyl peroxide, t-butyl cumyl peroxide, benzoyl peroxide, 2,5-dimethyl-2,5-di(t-butylperoxy)hexane, and 2,5-dimethyl-2,5-di(t-butylperoxy)hexyne-3. Also contemplated are peroxyester and peroxyketal initiators, for example: t-butylperoxy benzoate, t-amylperoxy benzoate, t-butylperoxy acetate, t-butylperoxy benzoate, di-t-butyl diperoxyphthalate, and t-butylperoxy isobutyrate. Also contemplated are hydroperoxides, for example: cumene hydroperoxide, t-butyl hydroperoxide, and hydrogen peroxide. Also contemplated are azo initiators, for example: 2-t-butylazo-2-cyanopropane, 2-t-butylazo-1-cyanocyclohexane, 2,2′-azobis(2,4-dimethylpentane nitrile), 2,2′-azobis(2-methylpropane nitrile), 1,1′-azobis(cyclohexanecarbonitrile), and azoisobutyronitrile (AIBN). Other similar materials are also contemplated such as, but not limited to, diacyl peroxides, ketone peroxides and peroxydicarbonates. It is also contemplated that combinations of more than one initiator, including combinations of different types of initiators, may be employed.

The initiators have characteristic minimum reaction initiation temperatures above which it will readily initiate a reaction and below which the reaction will proceed slowly or not at all. Consequently, the minimum temperature at which to carry out the grafting reaction is dictated by the selection of the initiator.

### Solvents

When solvents are employed, appropriate polar or non-polar liquids or process fluids may be used. Such solvents may facilitate materials handling as well as promoting the uniform distribution of reactants. Suitable solvents include volatile solvents which are readily removable from the grafted polymer after the reaction is complete. Solvents which may be used are those which can disperse or dissolve the components of the reaction mixture and which will not participate appreciably in the reaction or cause side reactions to a material degree. Several examples of solvents of this type include straight chain or branched aliphatic or alicyclic hydrocarbons, such as n-pentane, n-heptane, i-heptane, n-octane, i-octane, nonane, decane, cyclohexane, dihydronaphthalene, decahydronaphthalene and others. Specific examples of polar solvents include aliphatic ketones (for example, acetone), aromatic ketones, ethers, esters, amides, nitriles, sulfoxides such as dimethyl sulfoxide, water, etc. Non-reactive halogenated aromatic hydrocarbons such as chlorobenzene, dichlorobenzene, trichlorobenzene, dichlorotoluene and others are also useful as solvents. Combinations of solvents, and of polar and non-polar liquids or process fluids, are also contemplated for use in the present invention.

Useful solvents also include base stocks or process fluids which are suitable for incorporation into a final lubricating oil product. Any base stock or process fluids may be used which can disperse or dissolve the components of the reaction mixture without materially participating in the reaction or causing side reactions to an unacceptable degree. Hydroisomerized and hydrocracked base stocks, base stocks containing low or moderate levels of aromatic constituents, and fluid poly-α-olefins are contemplated for use herein. Aromatic constituents are desirably kept to low levels since aromatic materials may be reactive with each other or other reaction components in the presence of initiators. However, the use of base stocks or process fluids having aromatic constituents, while being less than optimum, is contemplated under this disclosure. These include base stocks or process fluids containing less than 50% aromatics, preferably less than 30% aromatics, more preferably less than 25% aromatics, alternatively less than 20% aromatics, alternatively less than 10% aromatics or alternatively less than 5% aromatics where these are weight percents.

Suitable base stocks of this kind include the Group 1,100 SUS, 130 SUS, or 150 SUS low pour solvent neutral base oils, and the Group II EHC base stocks available from ExxonMobil; HT 60 (P 60 N), HT 70 (P 70 N), HT 100 (P 100 N), and HT 160 (P 160 N) available from PetroCanada; and RLOP stocks such as 100 N and 240 N available from Chevron USA Products Co. In general, Group I, Group II, Group III, Group IV and Group V base stock categories are contemplated for use. Aromatic-free stocks such as polyalpha-olefins (“PAO”) may also be used as solvents.

The aromatic content in a suitable solvent or process fluid is preferably from about 0 to about 50 weight percent, alternatively about 0 to about 25 weight percent, alternatively from about 0 to about 15 weight percent

### Solution Reaction Conditions for Preparation of the Low Molecular Weight Multifunctional Graft Polymer

To prepare a multifunctional multiple-graft monomer low molecular weight graft polymer which displays both good soot handling and viscosity, sludge and varnish control, the respective monomer species which impart these performance characteristics are grafted onto the same low molecular weight polymer backbone. In order to generate a product exhibiting both soot handling and viscosity, sludge and varnish control, a coupling agent selected from the groups consisting of acylating agents and epoxides, preferably an acylating agent such as maleic anhydride, is grafted onto the low molecular weight polymer forming an acylated polymer, for example, a product containing succinic anhydride (SA) coupling groups. Next, an ethylenically unsaturated monomer or monomer grouping associated with sludge and varnish handling, for example, N-vinylimidazole (VIMA), is introduced and grafted onto the polymer backbone. Finally, an amine reactant or reactants capable of undergoing a condensation reaction with the coupling group, such as the succinic anhydride group noted above, is introduced and reacted with the coupling group, thereby forming, for example, an amide, imide, or amic acid, depending on the amine reactant or reactants. Hence, the reactants comprise a low molecular weight polymer, a graftable coupling agent, an amine capable of undergoing reaction with a coupling group, a graftable ethylenically unsaturated monomer group, and a free-radical initiator to promote the grafting reactions. More than one type of reactant may be used so the reactants may comprise one or more graftable low molecular weight polymers selected from polyolefins and/or polyesters, one or more graftable coupling agents, one or more amines capable of undergoing reaction with a coupling group, one or more aforesaid graftable ethylenically unsaturated monomers, and one or more free-radical initiators to promote the grafting reactions.

The multi-functional graft polymer of the present invention is prepared either neat, in solution or in a melt reactor. In general, grafting reactions will be conducted at a temperature sufficient to graft a least a portion of the coupling agent and ethylenically unsaturated monomer to the low molecular weight polymer.

In general, preparation of the multifunctional multiple-graft monomer low molecular weight graft polymer of the present invention in solution can be carried out as follows. The polymer to be grafted is provided in fluid form. For example, the low molecular weight polymer may be used neat or dissolved in a solvent, such as a hydrocarbon base oil suitable for use in a lubricating composition or any other suitable solvent or process fluid. The neat low molecular weight polymer or solution of the low molecular weight polymer is then heated to an appropriate reaction temperature. A graftable coupling agent is then introduced and grafted onto the polymer using an initiator such as a peroxide molecule, thereby forming a grafted polymer containing coupling groups. For example, when the coupling agent is maleic anhydride, a polymer having succinic anhydride coupling groups is formed. Subsequent to this reaction, a graftable ethylenically unsaturated monomer is introduced and grafted onto the polymer backbone using an appropriate initiator. The final step in this preparation of the multifunctional multiple graft monomer low molecular weight polymer of the present invention is reaction of an amine capable of undergoing a condensation reaction with the coupling groups on the low molecular weight polymer, for example, reacting the polymer having succinic anhydride coupling groups with either a primary or secondary amine. It should be noted that, in general, the reaction temperature will be maintained constant throughout the entire sequence of processes required for the preparation of the graft polymer.

More particularly, the low molecular weight polymer solution is placed into a suitable reactor such as a resin kettle, and the solution is heated, under inert blanketing, to the desired reaction temperature, and the reaction is carried out under the inert blanket. At a minimum, the reaction temperature should be sufficient to consume essentially all of the initiator during the time allotted for the reaction. For example, if di-t-butyl peroxide (DTBP) is used as the initiator the reaction temperature should be in the range of about 145° C. to about 230° C., alternatively from about 155° C. to about 210° C., alternatively from about 160° C. to about 200° C., alternatively from about 165° C. to about 190° C., alternatively from about 165° C. to about 180° C. The rate of decomposition of the initiators is temperature dependent and may be different for each initiator. Therefore, the choice of a particular initiator may require adjustment of either the reaction temperature or time or both. It should be noted that once a temperature is adopted, the temperature typically will be maintained constant throughout the entire sequence of processes required in the preparation of the graft polymer.

### Grafting of the Coupling Agent

The coupling agent is added to the low molecular weight polymer solution and dissolved. The contemplated proportions of the coupling agent to low molecular weight polymer are selected so that an effective percentage will graft directly onto the polymer backbone. The mole ratio of coupling agent to low molecular weight polymer can be in the range of from about 0.1, alternatively from about 0.5, alternatively from about 1, alternatively from about 1.5 mole, to about 9.9, alternatively to about 6, alternatively to about 5.5 moles of coupling agent per mole of polymer backbone.

The graftable coupling agent may be introduced into the reactor all at once, in several discrete charges, or at a steady rate over an extended period. The desired minimum rate of addition of the graftable coupling agent to the reaction mixture is selected from:

at least about 0.01%,

alternatively at least about 0.05%,

alternatively at least about 0.1%,

alternatively at least about 0.5%,

alternatively at least about 1%,

alternatively at least about 2%,

alternatively at least about 3%,

alternatively at least about 4%,

alternatively at least about 5%,

alternatively at least about 10%,

alternatively at least about 20%,

alternatively at least about 50%,

alternatively at least about 100%,

of the necessary charge of graftable coupling agent per minute. Any of the above values can represent an average rate of addition or the minimum rate of addition. When added over time, the graftable coupling agent can be added as discrete charges, at an essentially constant rate or at a rate which varies with time.

The desired maximum rate of addition is selected from:

at most about 0.5%,

alternatively at most about 1%,

alternatively at most about 2%,

alternatively at most about 5%,

alternatively at most about 10%,

alternatively at most about 20%,

alternatively at most about 50%,

alternatively at most about 100%

of the necessary charge of graftable coupling agent per minute. Any of the above values can represent an average rate of addition or the maximum rate of addition.

The graftable coupling agent may be added as a neat liquid, in solid or molten form, or “cut-back,” that is, diluted with a solvent. While it may be introduced neat, it is typically cut back with a solvent to avoid localized concentrations of the monomer as it enters the reactor. The monomer can be diluted up to about 50 times, preferably up to about 20 times, more preferably up to about 10 times, most preferably at least up to 3 times its weight or volume with a suitable solvent or dispersing medium.

### Initiator

An initiator is added to the solution comprised of polymer and coupling agent. The initiator can be added before, with or after the graftable coupling agent. When adding the initiator, it may be added all at once, in several discrete charges, or at a steady rate over an extended period. For example, the initiator may be added so that, at any given time, the amount of unreacted initiator present is much less than the entire charge or, preferably, only a small fraction of the entire charge. In one embodiment, the initiator may be added after substantially, most or the entire graftable coupling agent has been added, so there is an excess of both the graftable coupling agent and the low molecular weight polymer during essentially the entire reaction. In another embodiment, the initiator may be added along with, or simultaneously with, the graftable coupling agent, either at essentially the same rate or at a somewhat faster or slower rate, so there is an excess of polymer to unreacted initiator and unreacted coupling agent. For this embodiment, the ratio of unreacted initiator to unreacted coupling agent remains substantially constant during most of the reaction.

The contemplated proportions of the initiator to the graftable coupling agent and the reaction conditions are selected so that most, and ideally all of the graftable coupling agent will graft directly onto the polymer, rather than forming dimeric, oligomeric, or homopolymeric graft moieties or entirely independent oligomeric species. The contemplated minimum molar proportions of the initiator to the graftable coupling agent are from about 0.02:1 to about 2:1, alternatively from about 0.05:1 to about 2:1. No specific maximum proportion of the initiator is contemplated, though too much of the initiator may degrade the polymer, cause problems in the finished formulation and increase cost and, therefore, should be avoided.

The desired minimum rate of addition of the initiator to the reaction mixture is selected from:

at least about 0.005%

alternatively at least about 0.01%,

alternatively at least about 0.1%,

alternatively at least about 0.5%,

alternatively at least about 1%,

alternatively at least about 2%,

alternatively at least about 3%,

alternatively at least about 4%,

alternatively at least about 5%,

alternatively at least about 20%

alternatively at least about 50%,

of the necessary charge of initiator per minute. Any of the above values can represent an average rate of addition or the minimum rate of addition. When the initiator is added over time, the initiator can be added as discrete charges, at an essentially constant rate or at a rate which varies with time.

The desired maximum rate of addition of the initiator to the reaction mixture is selected from:

at most about 0.1%,

alternatively at most about 0.5%,

alternatively at most about 1%,

alternatively at most about 2%,

alternatively at most about 3%,

alternatively at most about 4%,

alternatively at most about 5%,

alternatively at most about 10%,

alternatively at most about 20%,

alternatively at most about 50%

alternatively at most about 100%,

of the necessary charge of initiator per minute. Any of the above values can represent an average rate of addition or the maximum rate of addition.

While the initiator can be added neat, it is typically cut back with a solvent to avoid high localized concentrations of the initiator as it enters the reactor. The initiator can be diluted by up to about 50 times, more preferably up to about 10 times, most preferably up to about 3 times its weight or volume with a suitable solvent or dispersing medium.

### Grafting of the Ethylenically Unsaturated Monomer

As noted above, the temperature typically will remain constant throughout preparation of the graft low molecular weight polymer. Hence, while at temperature, one or more aforesaid ethylenically unsaturated, aliphatic or aromatic monomers associated with sludge and varnish handling, for example, VIMA, is introduced along with an initiator. The contemplated proportions of the aforesaid ethylenically unsaturated monomer containing at least one of nitrogen and oxygen to the aforesaid low molecular weight polymer are selected so that an effective percentage of the monomer will graft directly onto the low molecular weight polymer backbone. The ethylenically unsaturated monomer, the monomer suitable for sludge/varnish control, may be added as several discrete charges, at an essentially constant rate, at a rate which varies with time, or all at once. The mole ratio of this monomer to low molecular weight polymer is from about 0.1, alternatively from about 0.5, alternatively from about 1, alternatively from about 1.5, to about 9.9, alternatively to about 6, alternatively to about 5.5 moles of the monomer per mole of the low molecular weight polymer:

The graftable ethylenically unsaturated monomer may be introduced into the reactor as several discrete charges, at an essentially constant rate, at a rate which varies with time, or all at once. The desired minimum rate of addition of the graftable, ethylenically unsaturated monomer to the reaction mixture is selected from:

at least about 0.01%,

alternatively at least about 0.05%,

alternatively at least about 0.1%,

alternatively at least about 0.5%,

alternatively at least about 1%,

alternatively at least about 2%,

alternatively at least about 3%,

alternatively at least about 4%,

alternatively at least about 5%,

alternatively at least about 10%,

alternatively at least about 20%,

alternatively at least about 50%,

alternatively at least about 100%,

of the necessary charge of such graftable monomer per minute. When added over time, the monomer can be added at an essentially constant rate, or at a rate which varies with time. Any of the above values can represent an average rate of addition or the minimum value of a rate which varies with time. The desired maximum rate of addition is selected from:

at most about 0.5%,

alternatively at most about 1%,

alternatively at most about 2%,

alternatively at most about 5%,

alternatively at most about 10%,

alternatively at most about 20%,

alternatively at most about 50%,

alternatively at most about 100%

of the necessary charge of graftable monomer per minute. Any of the above values can represent an average rate of addition or the maximum value of a rate which varies with time.

The graftable monomer may be added as a neat liquid, in solid or molten form, or cut back with a solvent. While it may be introduced neat, it is typically cut back with a solvent to avoid localized concentrations of the monomer as it enters the reactor. The monomer can be diluted by up to about 50 times, preferably up to about 10 times, more preferably up to about 3 times its weight or volume with a suitable solvent or dispersing medium.

The initiator can be added before, with or after the graftable monomer. It may be added into the reactor all at once, in several discrete charges, or at a steady rate over an extended period. For example, the initiator may be added so that, at any given time, the amount of unreacted initiator present is much less than the entire charge or, preferably, only a small fraction of the entire charge. In one embodiment, the initiator may be added after substantially most or all of the graftable monomer has been added, so there is an excess of both the graftable monomer and the polymer during essentially the entire reaction. In another embodiment, the initiator may be added along with the graftable monomer, either at essentially the same rate or at a somewhat faster or slower rate, so there is an excess of polymer to unreacted initiator and unreacted graftable monomer.

The contemplated proportions of the initiator to the graftable monomer and the reaction conditions are selected so that most, and ideally, all of the graftable monomer will graft directly onto the polymer, rather than forming dimeric, oligomeric, or homopolymeric graft moieties or entirely independent polymers. The contemplated minimum molar proportions of the initiator to the aforesaid ethylenically unsaturated, aliphatic or aromatic monomer are from about 0.02:1, preferably from about 0.05:1 to about 2:1. No specific maximum proportion of the initiator is contemplated, though too much of the initiator may degrade the polymer or, cause problems in the finished formulation and increase cost and, therefore, should be avoided.

As noted, the initiator may be introduced into the reactor in several (or, alternatively, many) discrete charges, or at a steady rate over an extended period. The desired minimum rate of addition of the initiator to the reaction mixture is selected from:

at least about 0.005%

alternatively at least about 0.01%,

alternatively at least about 0.1%,

alternatively at least about 0.5%,

alternatively at least about 1%,

alternatively at least about 2%,

alternatively at least about 3%,

alternatively at least about 4%,

alternatively at least about 5%,

alternatively at least about 20%

alternatively at least about 50%,

of the necessary charge of initiator per minute. The initiator can be added at an essentially constant rate, or at a rate which varies with time. Any of the above values can represent an average rate of addition or the minimum value of a rate which varies with time.

The desired maximum rate of addition of the initiator to the reaction mixture is selected from:

at most about 0.1%,

alternatively at most about 0.5%,

alternatively at most about 1%,

alternatively at most about 2%,

alternatively at most about 3%,

alternatively at most about 4%,

alternatively at most about 5%,

alternatively at most about 10%,

alternatively at most about 20%,

alternatively at most about 50%

alternatively at most about 100%,

of the necessary charge of initiator per minute. Any of the above values can represent an average rate of addition or the maximum value of a rate which varies with time.

While the initiator can be added neat, it is typically cut back with a solvent to avoid localized concentrations of the initiator as it enters the reactor. The initiator can be diluted by up to about 50 times, alternatively up to about 20 times, alternatively up to about 10 times, alternatively up to about 3 times its weight or volume with a suitable solvent or dispersing medium. The reaction is allowed to proceed to the extent required by the particular reactants.

### Formation of the Reaction Product of the Amine and Grafted Coupling Agent

The next step in the preparation of the multifunctional multiple-graft monomer low molecular weight graft polymer of the present invention is conversion of the coupling groups, typically the acyl groups on the acylated low molecular weight polymer, for example, the succinic anhydride substituents on the polymer, into the soot handling moiety via a condensation reaction with the amine reactant or reactants.

The contemplated mole ratios of amine reactant to the coupling group, for example the acyl group, in forming the amine-coupling agent reaction can be about 1:10 to about 6:1, alternatively from about 1:3 to about 4:1, alternatively from about 1:2 to about 4:1, or alternatively from about 1:2 to about 2:1. For example, for the succinic anhydride polymer substituent, a suitable mole ratio of amine reactant to acyl group can be from about 2:1 to 1:2, alternatively 1:1.

The solution may be maintained either at an elevated temperature, such as a temperature appropriate for carrying out the grafting reaction, or the temperature may be decreased to a temperature at which the grafting reaction does not occur. If the reactor temperature is decreased, the amine reactant may be introduced into the reactor all at once and blended into the polymer solution. The reactor temperature is then elevated in order to carry out the reaction between the acylated polymer and the amine reactant. Alternatively, the reactor may be maintained at an elevated temperature, and the amine reactant may be fed to the reactor either relatively slowly or rapidly, allowing for the reaction between the acylated polymer and the amine reactant to proceed. The reactants are maintained at temperature until the reaction with the amine is complete, thereby forming the amine-coupling agent reaction product. An inert blanket may be maintained during this stage of preparation of the graft polymer.

The amine reactant may be introduced into the reactor in several discrete charges, at a constant rate over an extended period of time, at a rate which varies with time, or all at once. That is, the desired rate of addition of amine reactant is as follows:
at least about 0.2%,
alternatively at least about 0.5%,
alternatively at least about 1%,
alternatively at least about 2%,
alternatively at least about 3%,
alternatively at least about 4%,
alternatively at least about 5%,
alternatively at least about 20%
alternatively at least about 50%,
alternatively at least about 100%,
   of the necessary charge of amine reactant per minute. Any of the above values can represent an average rate of addition or the minimum value of a rate which varies with time.

After the reaction has gone essentially to completion, the heat is removed and the reaction product is allowed to cool in the reactor with mixing or it may be removed prior to cooling.

### Graft Monomer Ratios

The mole ratios of the coupling agent to the ethylenically unsaturated monomer range can be from about 1:100 to about 100:1, alternatively from about 1:20 to about 20:1, alternatively from about 1:10 to about 10:1, alternatively from about 1:2 to about 2:1.

The mole ratios of product formed by the reaction of the coupling groups and amine to the graftable low molecular weight polymer are understood to be the same as those noted above for the coupling agent, namely, from about 0.1:1, alternatively from about 0.5:1, alternatively from about 1:1, alternatively from about 1.5:1, to about 9.9:1, alternatively to about 6:1, alternatively to about 5.5:1 moles of such reaction product per mole of the low molecular weight polymer.

It is contemplated that total mole ratio of graft monomers comprising both the amine-coupling agent reaction product and the ethylenically unsaturated nitrogen-containing and/or oxygen-containing monomer to the polymer backbone is suitably from about 0.5:1, alternatively from about 1:1, alternatively from about 2:1, alternatively from about 3:1, to about 20:1, alternatively to about 15:1, alternatively to about 11:1.

Based upon these graft concentrations, the multifunctional multiple-graft monomer low molecular weight graft polymer of the present invention may contain about 0.5 moles of the amine-coupling agent reaction product, a monomer that can control soot, and about 0.5 moles of the ethylenically unsaturated monomer, a monomer that can control sludge and varnish, per mole of low molecular weight polymer. The multifunctional multiple-graft monomer low molecular weight graft polymer of the present invention may be formulated to contain about 2 moles of the amine-coupling agent reaction product monomer that can control soot, and about 4 moles of the ethylenically unsaturated nitrogen and/or oxygen monomer that can control sludge and varnish, per mole of low molecular weight polymer. The multifunctional multiple-graft monomer low molecular weight graft polymer of the present invention may be formulated to contain about 3 moles of the amine-coupling agent reaction product monomer that can control soot, and about 1 mole of the ethylenically unsaturated monomer that can control sludge and varnish, per mole of low molecular weight polymer.

As noted, the mole ratios of each of the grafted substituents, namely, either the amine-coupling agent reaction product or the ethylenically unsaturated monomer, relative to the polymer backbone may range from 0.1:1 to 9.9:1. Based upon this range of mole ratios of each of the grafted substituents, namely, the amine-coupling agent reaction product and the ethylenically unsaturated monomer, to the polymer backbone, the relative mole ratios of one substituent to the other may range from about 1:1 to about 100:1. By way of illustration, if a first substituent has a mole ratio to polymer of 0.1:1 and the second substituent has a mole ratio of 1:1, then the relative mole ratio of the second substituent to the first substituent is 10:1.

### Melt Reaction Conditions for Preparation of the Low Molecular Weight Multifunctional Graft Polymer

The grafting reaction can be carried out under polymer melt reaction conditions in an extrusion reactor, a heated melt-blend reactor, a Banbury mill or other material blenders or mixers, for example, an extruder. The term extruder used in this specification should be understood as being exemplary of the broader class of blenders or mixers which may be used for melt-blending according to the present invention.

To carry out the melt reaction, it is desirable to establish suitable process design parameters for the reactive extruder to insure that the operating parameters and conditions will generate products meeting the desired specifications. The operating conditions and parameters appropriate for carrying out reactive extrusion include, but are not limited to, criteria for the reactant feed ports, the reactant feed systems which include feed rate controllers and monitors, the polymer feed system, which includes the polymer feed port, feed rate controllers and monitors. The polymer feed system may include, as required, facilities to handle low molecular weight polymers as well as high molecular weight polymers. In addition to the above noted feed considerations, other criteria for the extruder design are to be considered. These include, among others, the screw design and its size, barrel diameter and length, die configuration and open cross-section, systems for heating the extruder, or at times cooling the extruder, and for controlling extruder temperature, such as, barrel temperature and die temperature, screw speed, and both pre-extrusion and post-extrusion conditions. The precise conditions needed to generate products meeting the product targets can be established by those skilled in the art. It should be noted that during its operation, the extruder can be maintained under essentially aerobic conditions, or may be purged or blanketed with an appropriate inerting material to create anaerobic or near anaerobic operating conditions.

The appropriate reactant feed concentrations and conditions may be based upon the ranges disclosed above for the solvent based grafting reaction. These include the appropriate feed rates, concentrations and conditions of the low molecular weight polymer or low molecular weight polymers, the graftable monomers such as the graftable ethylenically unsaturated monomer or monomers, the acylating agent or agents, the initiator or initiators and the amine reactant or reactants. Examples of the concentrations and conditions referred to include, among others, the relative concentrations of the graftable ethylenically unsaturated monomer and of the acylating agent to both the polymer and the initiator and also of the relative concentration of amine reactant to acylating agent.

The contemplated minimum and maximum molar proportions are, in general, the same as those previously identified for the solvent based reactions. As had been noted for the solvent based reactions, the reactants may be fed to the extruder, either, as a mixture of components or separately, as individual components.

The reactants may be added either neat, or “cut-back,” that is, diluted with solvent, in order to avoid localized regions of elevated species concentration and as a method of controlling reactant feed. Representative solvents include volatile as well as non-volatile fluids. The solvents considered include base oils conventionally used in lubricant compositions, as defined in this specification, mineral spirits, non-polar solvents, polar solvents and other solvents known to those skilled in the art which includes solvents such as water, methanol and acetone. The concentration of reactant, relative to solvent, may range from about 10 wt % to about 90 wt %. In general, the concentrations and conditions for carrying out the grafting reaction via reactive extrusion are chosen in order to promote grafting of the reactive reagents directly onto the low molecular weight polymer, rather than the reagents reacting to form dimeric, oligomeric, or homopolymeric graft moieties or, even, independent homopolymers. Typically the reactants are introduced either neat or “cut-back” with, for example, 75% solvent in order to avoid localized regions of elevated concentration, as noted above.

In carrying out the graft reaction, the low molecular weight polymer, essentially as a “neat” material, is fed to the extruder at a constant rate and brought to its appropriate reaction condition. The graftable acylating agents, the graftable ethylenically unsaturated monomers, the initiators and the amine compounds are also metered into the extruder at a constant rate. This may be done either through the same feed port as that of the polymer or through separate reactant feed ports. That is, the graftable reactants and initiator may be fed, essentially, together with the polymer into the same extruder zone and, thereby, reacted with the reactants, or, alternatively, delivery of the graftable reagents and initiator may be somewhat delayed, by being introduced downstream from the polymer feed port into reaction zones which are separated from the polymer feed port by the use of appropriate screw seal elements. With respect to the initiator, it may be introduced, either before, together with, or after the respective graftable reagents, namely, either into the same extruder zone or into zones which are either before or after the graftable reactant. The reaction zones are established by appropriate screw seal elements.

The absolute feed rates of all of the reactants, namely, the low molecular weight polymer, the acylating agents, the ethylenically unsaturated monomers and the initiators and the relative concentration of the latter three with respect to the polymer are adjusted and maintained constant to yield the desired product composition. In addition to the graftable reagents, an amine capable of reacting with the acylating agent may be fed to the extruder, downstream from the grafted polymer, to complete the preparation of the low molecular weight multifunctional dispersant graft polymer.

In one embodiment of the preparation of the low molecular weight multifunctional multiple graft polymer, only one, namely the first, reactant might be grafted via an extrusion process while a solution process is used to complete the preparation of the low molecular weight multifunctional multiple graft polymer. In another embodiment, two reactants might be grafted using an extrusion process and a solution process may be used to complete the preparation of the product. In another embodiment, the preparation might be carried out, in its entirety, using the extrusion process.

One or more polymers, acylating agents, graftable ethylenically unsaturated monomers, initiators and amines may be used to produce the multifunctional graft polymer of the present invention. In a preferred embodiment, one low molecular weight polymer, one acylating agent, one graftable ethylenically unsaturated monomer, one or more initiators and one amine may be used in the preparation of the low molecular weight multifunctional multiple graft polymer. In alternate embodiments, more than one low molecular weight polymer, more than one acylating agent more than one graftable ethylenically unsaturated monomer, more than one initiator and more than one amine may be used for grafting. In addition, the polymer reactant may be comprised of both low and high molecular weight polymers.

In alternate embodiments of this invention, as explained above, the graftable monomers, namely, the acylating monomer, the ethylenically unsaturated monomer comprising nitrogen and/or oxygen, and combinations thereof, and the initiator may be introduced together at the appropriate relative concentration. By carefully selecting the operating conditions, in terms of residence times, extruder zone temperatures, screw speed, reactant feed rates, the extruder process may be customized to use a variety of different reactants, any of the various polymers disclosed herein, any of the graftable monomers disclosed herein, any of the initiators disclosed herein and any of the amines disclosed herein. If required, inhibitors may be used to yield novel products.

In one embodiment, the reactants, for example, the acylating agent or acylating agents, the graftable ethylenically unsaturated monomer or monomers, the initiator or initiators and the amine or amines for the condensation reaction, are fed separately. It is advantageous if the low molecular weight polymer be the first reactant which is fed to the extruder.

The melt reaction may also be carried out using a mixture of both a low molecular weight polymer, having a weight average molecular weight of 9950 or less and a high molecular weight polymer, having a weight average molecular weight of 10,000 to 750,000 alternatively to 500,000. For example, the two polymer types may be fed to the extruder either simultaneously or separately. These polymer types may be blended together, either prior to introduction into the extruder or, if two separate polymer feeds are employed, blending of the polymers may be carried out in the extruder. Blending of the polymer types prior to the introduction of the other reactants, namely the acylating agent, the graftable ethylenically unsaturated monomer, the initiator and the amine capable of reaction with the acylated polymer, is advantageous. Alternatively, the two polymer types may be fed, separately, into the reaction zones and then reacted—with the acylating agent, the graftable ethylenically unsaturated monomer, the initiator and the amine capable of reaction with the acylated polymer. Alternatively, the multifunctional graft product comprised of both low and high molecular weight polymers may be generated by initially carrying out a graft reaction in the extruder and follow this graft reaction by reaction in a solvent, namely, completing generation of the multifunctional product in solution. In one embodiment, the polymer is the first reactant fed to the extruder. Alternatively, the entire reaction using both high and low molecular weight polymers can be carried out in solution.

### High Molecular Weight Polymers and Other Polymers

A wide variety of polyolefins, modified polyolefins, polyesters, and modified polyesters (which may or may not have pendant unsaturation) are contemplated for use as the high molecular weight polymers. Examples of such polyolefins and polyesters include homopolymers, copolymers, terpolymers, and higher such as, but not limited to, polyethylene, polypropylene, ethylene-propylene copolymers, polymers containing two or more monomers, polyisobutene, polymethacrylates, polyacrylates, polyalkylstyrenes, partially hydrogenated polyolefins of butadiene and styrene and copolymers of isoprene, such as polymers of styrene and isoprene. EPDM (ethylene/propylene/diene monomer) polymers, ethylene-propylene octene terpolymers and ethylene-propylene ENB terpolymers, are also contemplated for use herein. The use of mixtures of polyolefins as well as mixtures of polyesters for making the multifunctional graft polymer of the present invention is also contemplated. The use of chemical and physical mixtures of polyolefins and polyesters is also contemplated. The high molecular weight polyolefins contemplated herein may have weight average molecular weights of from about 10,000 to about 750,000, alternatively from about 20,000 to about 500,000. The high molecular weight polyolefins may have polydispersities from about 1 to about 15. The high molecular weight polyesters contemplated herein may have weight average molecular weights of from about from about 10,000 to about 750,000, alternatively from about 20,000 to about 750,000.

The melt reaction product may be used either neat, or dissolved in an appropriate solvent. In one embodiment, the grafted polymer product is dissolved in an appropriate solvent or base stock in order to facilitate handling of the low molecular weight multifunction multiple graft polymer and to facilitate lubricant blending using the graft product.

### Lubricating Oil Compositions

The lubricating oil compositions of the present invention preferably comprise the following ingredients in the stated proportions:
A. from about 60%, alternatively from about 65%, alternatively from about 70%, to about 99% by weight, of one or more base oils;
B. from about 0.02%, alternatively from about 0.05%, alternatively from about 0.15%, alternatively from about 0.25%, to about 20%, alternatively to about 10%, alternatively to about 5%, alternatively to 2% by weight of one or more of the multifunctional multiple-graft monomer low molecular weight graft polymers of the present invention;
C. from about 0%, alternatively from about 0.05%, alternatively from about 0.15%, alternatively from about 0.1%, to about 15%, alternatively to about 10%, alternatively to about 5%, alternatively to about 2.5% by weight of one or more grafted higher molecular weight polymers having a weight average molecular weight greater than 10,000.
D. from about 0%, alternatively from about 0.5%, alternatively from about 0.15%, alternatively from about 0.1%, to about 15%, alternatively to about 10%, alternatively to about 5%, alternatively to about 2.5% by weight of one or more polymers other than grafted polymers;
E. from 0%, alternatively from about 0.2%, alternatively from about 0.5%, alternatively from about 0.7%, to about 15%, alternatively to about 10%, alternatively to about 8%, alternatively to about 6% by weight of one or more dispersants which are not grafted according to the present invention;
F. from about 0%, alternatively from about 0.3%, alternatively from about 0.5% to about 10%, alternatively to about 8%, alternatively to about 6%, alternatively to about 4% by weight, of one or more detergents;
G. from about 0%, alternatively from about 0.04%, alternatively from about 0.06%, to about 5%, alternatively to about 3%, alternatively to about 2% by weight of one or more anti-wear agents;
H. from about 0%, alternatively from about 0.05%, alternatively from about 0.1% to about 5%, alternatively to about 3%, alternatively to about 2.5%, alternatively to about 2% by weight of one or more anti-oxidants; and
I. from about 0%, alternatively from about 0.005%, to about 4%, alternatively to about 3%, alternatively to about 2%, alternatively to about 1.5% by weight of minor ingredients such as friction modifiers, pour point depressants, and anti-foam agents.

The percentages of C through I may be calculated based on the form in which they are commercially available. The function and properties of each ingredient identified above and several examples of such ingredients are summarized below.

### Base Oils

Any of the petroleum or synthetic base oils (Groups I, II, III, IV and V) previously identified as being suitable as solvents or process solvents for the graftable low molecular weight polymers of the present invention can be used as the base oil. Indeed, any conventional lubricating oil or combinations thereof may also be used.

### Multifunctional Multiple-Graft Monomer Low Molecular Weight Graft Polymers

Since the multifunctional multiple-graft monomer low molecular weight graft polymer of the present invention possesses soot, sludge and varnish handling properties it can be used in place of part or all of the additives used to control soot, sludge and varnish that are used in lubricant formulations.

Grafted low molecular weight polyolefins and/or low molecular weight polyesters disclosed in prior art can also be used in combination with the multifunctional multiple-graft monomer low molecular weight graft polyolefins and/or graft polyesters of the present invention.

### Grafted and Non-Grafted Viscosity Modifiers

The conventional viscosity index improving polymers, including, for example, polyolefins and polyesters, can be used in the lubricating oil formulations of the present invention. Several examples of polymers contemplated for use herein include those suggested at column 1, lines 29-32 of U.S. Pat. No. 4,092,255, the disclosure of which is incorporated by reference herein in its entirety: Polymers contemplated for use herein include, for example, polyisobutenes, polymethacrylates, polyalkylstyrenes, hydrogenated and partially hydrogenated low molecular weight polymers of butadiene and styrene, amorphous polyolefins of ethylene and propylene, ethylene-propylene diene low molecular weight polymers, polyisoprene, and styrene-isoprene. Similarly, functionalized polyolefins such as those disclosed in U.S. Pat. Nos. 4,092,255; 5,814,586; and 5,874,389, and references cited therein, are incorporated by reference herein in their entirety.

### Dispersants

Dispersants help suspend insoluble engine oil oxidation products, thus preventing sludge flocculation and precipitation or deposition of particulates on metal parts. Suitable dispersants include alkyl succinimides such as the reaction products of oil-soluble polyisobutylene succinic anhydride with ethylene amines such as tetraethylene pentamine and borated salts thereof.

Such conventional dispersants are contemplated for use herein. Several examples of dispersants include those listed in U.S. Pat. No. 4,092,255 at column 1, lines 38-41. Dispersants contemplated for use herein include, for example, succinimides or succinic esters, having a polyolefin, such as a polyolefin of isobutene or propylene, on the carbon in a position alpha to the succinimide carbonyl. These additives are useful for maintaining the cleanliness of an engine or other machinery.

### Detergents

Detergents used to maintain engine cleanliness can be incorporated in the present lubricating oil compositions. These materials include the metal salts of sulfonic acids, alkyl phenols, sulfurized alkyl phenols, alkyl salicylates, naphthenates, and other soluble mono- and dicarboxylic acids. Basic metal salts, such as basic alkaline earth metal sulfonates, especially calcium and magnesium salts, are frequently used as detergents. Such detergents are particularly useful for keeping the insoluble particulate materials in an engine or other machinery in suspension. Other examples of detergents contemplated for use herein include those recited in U.S. Pat. No. 4,092,255, at column 1, lines 35-36. Detergents contemplated for use herein include, for example, sulfonates, phenates, or organic phosphates of polyvalent metals.

### Anti-Wear Agents

Anti-wear agents, as their name implies, reduce wear of metal parts. Zinc dialkyldithiophosphates and zinc diaryldithiophosphates, and organo molybdenum compounds, such as molybdenum dialkyldithiocarbamates, are representative of conventional anti-wear agents.

### Anti-Oxidants

Oxidation inhibitors, or anti-oxidants, reduce the tendency of lubricating oils to deteriorate in service. This deterioration can be evidenced by increased oil viscosity, the presence of oxidation products in the oil and by the products of oxidation such as sludge and varnish-like deposits on the metal surfaces. Such oxidation inhibitors include alkaline earth metal salts of alkylphenolthioesters suitably having C₅ to C₁₂ alkyl side chains, e.g., calcium nonylphenol sulfide, dioctylphenylamine, phenyl-alpha-naphthylamine, phosphosulfurized or sulfurized hydrocarbons, and organo molybdenum compounds such as molybdenum dialkyldithiocarbamates. Use of conventional antioxidants may be reduced or eliminated by the use of the multifunctional multiple-graft monomer low molecular weight graft polymer of the present invention.

### Minor Ingredients

Other minor ingredients are contemplated for incorporation in the lubricating oil compositions containing the multifunctional multiple-graft monomer low molecular weight graft polymer of the present invention. A non-exhaustive list of such additives includes pour point depressants, rust inhibitors, as well as extreme pressure additives, friction modifiers, seal swell agents, antifoam additives, and dyes.

### Fuel Composition

The fuel compositions of the present invention comprise a major proportion of hydrocarbon based liquid fuels, such as gasoline, diesel fuel or aviation fuels. Such fuel compositions contain the multifunctional graft polymer of the present invention in order to impart dispersant and detergent properties to the fuel. The multifunctional low molecular weight graft polymer of the present invention is present in such fuel compositions at a level in the range of from about 5 ppm, alternatively from about 10 ppm, alternatively about 25 ppm, alternatively from about 50 ppm, alternatively from about 60 ppm, to about 5,000 ppm, alternatively to about 1,500 ppm, alternatively to about 1,000 ppm by weight. These fuels may also contain other components such as alcohols and ethers, as well as other additives.

### EXAMPLES

### Example 1

### Preparation of Low Molecular Weight Multifunctional Graft Polymer

A 500 milliliter resin kettle equipped with an electric heating mantle, stirrer, thermometer, metering syringe pump feed system and a gas inlet is charged with 350 grams (0.35 mole) of a low molecular weight ethylene-propylene polymer having a weight average molecular weight of 1000.

The gas inlet permits the gas to be fed either below or above the surface of the solution. The solution is heated to 170° C. and maintained at temperature throughout the preparation. During heating, the low molecular weight ethylene-propylene polymer is purged with an inerting gas (CO₂) fed below the surface of the solution. When the solution reaches the temperature of 170° C., the purge gas is redirected to flow over the surface of the low molecular weight polymer. The flow of the blanketing gas is maintained throughout the preparation of the graft product.

A single charge of about 38 grams (0.39 mole) of maleic anhydride is added to the low molecular weight polymer and dissolved. This is followed by a 60 minutes metered addition to the reactor of a solution containing about 15 grams (0.1 mole) di-t-butyl peroxide (DTBP) made up to about 50 milliliters with heptane. The grafting reaction is allowed to continue for 30 minutes beyond the 60 minutes allotted for the initiator feed. The purge gas is then redirected to flow under the low molecular weight polymer solution for 4 hours in order to strip the unreacted maleic anhydride and heptane. The DTBP promoted grafting of the maleic anhydride onto the low molecular weight polymer forming the corresponding succinic anhydride (SA) acylated graft product.

The next step is grafting of 1-vinylimidazole (VIMA) onto the acylated low molecular weight polymer prepared in the previous step. To carry out this segment of the preparation, two solutions are prepared, one containing about 35 grams (0.37 mole) of VIMA made up to about 50 milliliters with acetone and the other containing about 15 grams (0.1 mole) of DTBP made up to about 50 milliliters with heptane. Using syringe pumps, these solutions are delivered simultaneously to the reactor over a 60 minutes period. The grafting reaction is then allowed to proceed for an additional 30 minutes beyond the 60 minutes allotted for the initiator feed. After the VIMA reaction is essentially complete a charge of about 72 grams (0.39 mole) of N-phenyl-1,4-phenylenediamine is added over a period of about 1 hour to the mixture and reacted with the acyl groups on the dual graft low molecular weight polymer formed in the previous steps, thereby, generating the low molecular weight dual monomer graft polymer product. Again, the purge gas is redirected to flow under the low molecular weight polymer solution in order to strip the volatiles such as the heptane and acetone.

### Example 2

### Preparation of Low Molecular Weight Multifunctional Graft Polymer

A 500 milliliter resin kettle equipped with an electric heating mantle, stirrer, thermometer, metering syringe pump feed system and a gas inlet is charged with 350 grams (0.088 mole) of a low molecular weight ethylene-propylene polymer having a weight average molecular weight of 4000.

The gas inlet permits the gas to be fed either below or above the surface of the solution. The solution is heated to 170° C. and maintained at temperature throughout the preparation. During heating, the low molecular weight polymer is purged with an inerting gas (CO₂) fed below the surface of the solution. When the solution reaches the temperature of 170° C., the purge gas is redirected to flow over the surface of the low molecular weight polymer. The flow of the blanketing gas is maintained throughout the preparation of the graft product.

A single charge of about 10 grams (0.1 mole) of maleic anhydride is added to the low molecular weight polymer and dissolved. This is followed by a 60 minutes metered addition to the reactor of a solution containing about 4.4 grams (0.03 mole) di-t-butyl peroxide (DTBP) made up to about 30 milliliters with heptane.

The grafting reaction is allowed to continue for 30 minutes beyond the 60 minutes allotted for the initiator feed. The purge gas is then redirected to flow under the low molecular weight polymer solution for 4 hours in order to strip the unreacted maleic anhydride and the heptane. The DTBP promoted grafting of the maleic anhydride onto the low molecular weight polymer forming the corresponding succinic anhydride (SA), the acylated graft product.

The next step is grafting of 1-vinylimidazole (VIMA) onto the acylated low molecular weight polymer prepared in the previous step. To carry out this segment of the preparation, two solutions are prepared, one containing about 9 grams (0.098 mole) of VIMA made up to about 30 milliliters with acetone and the other containing about 4.3 grams (0.029 mole) of DTBP made up to about 30 milliliters with heptane. Using syringe pumps, these solutions are delivered simultaneously to the reactor over a 60 minutes period. The grafting reaction is then allowed to proceed for an additional 30 minutes beyond the 60 minutes allotted for the initiator feed. After the VIMA reaction is essentially complete a charge of about 18 grams (0.098 mole) of N-phenyl-1,4-phenylenediamine is added over a period of 4 hours to the mixture and reacted with the acyl groups on the dual graft low molecular weight polymer formed in the previous steps, thereby, generating the dual-monomer graft polymer product. Again, the purge gas is redirected to flow under the low molecular weight polymer solution in order to strip the volatiles such as the heptane and acetone.

### Example 3

### Preparation of Low Molecular Weight Multifunctional Graft Polymer

A 500 milliliter resin kettle equipped with an electric heating mantle, stirrer, thermometer, metering syringe pump feed system and a gas inlet is charged with 350 grams of a 30% by weight solution of a low molecular weight ethylene-propylene polymer having a weight average molecular weight of 6000. The solution is prepared by dissolving about 105 grams (0.0175 mole) of the low molecular weight polymer in 245 grams of a commercially available hydrorefined base stock.

The gas inlet permits the gas to be fed either below or above the surface of the solution. The solution is heated to 170° C. and maintained at temperature throughout the preparation. During heating, the low molecular weight polymer solution is purged with an inerting gas (CO₂) fed below the surface of the solution. When the solution reaches the temperature of 170° C., the purge gas is redirected to flow over the surface of the low molecular weight polymer solution. The flow of the blanketing gas is maintained throughout the preparation of the graft product.

A single charge of about 5.7 grams (0.058 mole) of maleic anhydride is added to the low molecular weight polymer solution and dissolved. This is followed by a 60 minutes metered addition to the reactor of a solution containing about 2.7 grams (0.019 mole) di-t-butyl peroxide (DTBP) made up to about 20 milliliters with heptane. The grafting reaction is allowed to continue for 30 minutes beyond the 60 minutes allotted for the initiator feed. The purge gas is then redirected to flow under the low molecular weight polymer solution for 4 hours in order to strip heptane and the unreacted maleic anhydride. The DTBP promoted grafting of the maleic anhydride onto the low molecular weight polymer forming the corresponding succinic anhydride (SA) acylated graft product.

The next step is grafting of 1-vinylimidazole (VIMA) onto the acylated low molecular weight polymer prepared in the previous step. To carry out this segment of the preparation, two solutions are prepared, one containing about 5.3 grams (0.056 mole) of VIMA made up to about 20 milliliters with acetone and the other containing about 2.77 grams (0.019 mole) of DTBP made up to about 20 milliliters with heptane. Using syringe pumps, these solutions are delivered simultaneously to the reactor over a 60 minutes period. The grafting reaction is then allowed to proceed for an additional 30 minutes beyond the 60 minutes allotted for the initiator feed. After the VIMA reaction is essentially complete a charge of about 10.7 grams (0.058 mole) of N-phenyl-1,4-phenylenediamine is added quickly to the mixture and reacted with the acyl groups on the dual graft low molecular weight polymer formed in the previous steps, thereby, generating the dual-monomer graft polymer product. Again, the purge gas is redirected to flow under the low molecular weight polymer solution in order to strip the volatiles such as the heptane and acetone.

### Example 4

### Preparation of Low Molecular Weight Multifunctional Graft Polymer

A 500 milliliter resin kettle equipped with an electric heating mantle, stirrer, thermometer, metering syringe pump feed system and a gas inlet is charged with 350 grams (0.088 mole) of a low molecular weight ethylene-propylene polymer having a weight average molecular weight of 4000.

The gas inlet permits the gas to be fed either below or above the surface of the solution. The solution is heated to 170° C. and maintained at temperature throughout the preparation. During heating, the low molecular weight polymer is purged with an inerting gas (CO₂) fed below the surface of the solution. When the solution reaches the temperature of 170° C., the purge gas is redirected to flow over the surface of the low molecular weight polymer. The flow of the blanketing gas is maintained throughout the preparation of the graft product.

A single charge of about 20 grams (0.2 mole) of maleic anhydride is added to the low molecular weight polymer and dissolved. This is followed by a 60 minutes metered addition to the reactor of a solution containing about 8.8 grams (0.06 mole) di-t-butyl peroxide (DTBP) made up to about 30 milliliters with heptane. The grafting reaction is allowed to continue for 30 minutes beyond the 60 minutes allotted for the initiator feed. The purge gas is then redirected to flow under the low molecular weight polymer solution for 4 hours in order to strip the unreacted maleic anhydride and heptane. The DTBP promoted grafting of the maleic anhydride onto the low molecular weight polymer forming the corresponding succinic anhydride, the acylated graft product.

The next step is grafting of 1-vinylimidazole (VIMA) onto the acylated low molecular weight polymer prepared in the previous step. To carry out this segment of the preparation, two solutions are prepared, one containing about 27 grams (0.29 mole) of VIMA made up to about 40 milliliters with acetone and the other containing about 12.9 (0.088 mole) grams of DTBP made up to about 40 milliliters with heptane. Using syringe pumps, these solutions are delivered simultaneously to the reactor over a 60 minutes period. The grafting reaction is then allowed to proceed for an additional 30 minutes beyond the 60 minutes allotted for the initiator feed. After the VIMA reaction is essentially complete a charge of about 37 grams (0.2 mole) of N-phenyl-1,4-phenylenediamine is added quickly to the mixture and reacted with the acyl groups on the dual graft low molecular weight polymer formed in the previous steps, thereby, generating the dual-monomer graft polymer product. Again, the purge gas is redirected to flow under the low molecular weight polymer solution in order to strip the volatiles such as the heptane and acetone.

### Example 5

### Melt Preparation of Low Molecular Weight Multifunctional Graft Polymer

A 2 inch barrel twin screw counter-rotating extruder having an L/D of 57 is used to produce the low molecular weight multifunctional graft polymer. The extruder is equipped with a hot oil heating system. The reactant feed systems are flexible. For example, the polymer feed system is designed to handle neat low molecular weight polymers, a slurry of low molecular weight and high molecular weight polymers as well as high molecular weight polymers. Since reactant feed rates are important for melt reactor or extruder reactions, it is necessary to insure that the feed systems are designed to deliver reactants, as best as possible, at a continuous, constant and uniform rate to meet the feed rates necessary to generate the desired graft product composition. Reactant feed systems are available for handling the maleic anhydride, di-t-butyl peroxide, VIMA and N-phenyl-1,4-phenylenediamine. As noted above, the feed systems are designed to provide precisely metered, continuous and constant delivery rates of reactant. The extruder is designed so that each of the reactants is introduced into a separate sealed zone.

Generation of the low molecular weight multifunctional graft polymer is carried out by introducing into the first sealed zone at a rate of 1 mole per hour a low molecular weight polymer having a weight average molecular weight of 9000. The maleic anhydride is metered into the second sealed zone at a rate of 1 mole per hour. Mixing elements are used in order to satisfactorily disperse the maleic anhydride in the polymer. The mixture is then introduced into the third sealed reaction zone into which DTBP is fed at a rate of about 0.2 mole per hour. The acylated low molecular weight polymer is fed into the next sealed reaction zone into which VIMA is fed at a rate of 1 mole per hour. This mixture is fed to the next sealed reaction zone into which DTBP is fed at a rate of 0.2 mole per hour. The preparation of the low molecular weight multifunctional graft polymer is completed in the next reaction zone into which N-phenyl-1,4-phenylenediamine is fed at a rate of 0.5 mole per hour. The final product is extruded through a multi-hole die into a water bath and collected.

### Example 6

### Melt and Solution Preparation of Low Molecular Weight Multifunctional Graft Polymer

The multifunctional low molecular weight graft polymer is also produced using a combination of melt and solution processes. The first step in the process is a melt process. This is carried out by introducing into the first sealed zone at a rate of 1 mole per hour a low molecular weight polymer having a weight average molecular weight of 9000. The maleic anhydride is metered into the second sealed zone at a rate of 1.5 moles per hour. Mixing elements are used in order to satisfactorily disperse the maleic anhydride in the polymer melt. The mixture is then introduced into the third sealed reaction zone into which DTBP is fed at a rate of about 0.4 mole per hour forming an acylated polymer. The acylated polymer is extruded through a multi-hole die into a water bath and collected. A 30% solution of the acylated polymer is prepared. The solution is prepared by dissolving 450 grams (0.0.05 mole) of the acylated polymer in 1050 grams of a commercially available hydrorefined base stock.

The solution phase of the process is carried out in a 500 milliliter resin kettle equipped with an electric heating mantle, stirrer, thermometer, metering syringe pump feed system and a gas inlet. The resin kettle is charged with 350 grams of the 30% by weight solution of the acylated low molecular weight polymer having a weight average molecular weight of approximately 9000. After being raised to temperature, 170° C., 7 grams (0.077 mole) of 1-vinylimidazole (VIMA) made up to about 20 milliliters with acetone and about 5 grams (0.034 mole) of DTBP made up to about 20 milliliters with heptane are metered in simultaneously over a period of 60 minutes. The grafting reaction is then allowed to proceed for an additional 30 minutes beyond the 60 minutes allotted for the initiator feed. After the VIMA reaction is essentially complete a charge of about 5.5 grams (0.03 mole) of N-phenyl-1,4-phenylenediamine is added over a period of 4 hours to the mixture and reacted with the acyl groups on the dual graft low molecular weight polymer formed in the previous steps, thereby, generating the dual-monomer graft polymer product. Again, the purge gas is redirected to flow under the low molecular weight polymer solution in order to strip the volatiles such as the heptane and acetone.

### Example 7

### Preparation of Low Molecular Weight Multifunctional Graft Polymer

A 500 milliliter resin kettle equipped with an electric heating mantle, stirrer, thermometer, metering syringe pump feed system and a gas inlet was charged with a solution containing 25% by weight of 1300 MW polyisobutylene succinic anhydride (PIBSA) having a KVis at 100° C. of 1264.4 cSt. The solution was prepared by dissolving 125 grams (0.096 mole) PIBSA, supplied by Dover Chemical Co. in 375 grams of FHR 100 base stock. The KVis of the solution was 12.5 cSt at 100° C.

The gas inlet permits the gas to be fed either below or above the surface of the solution. The solution is heated to 170° C. and maintained at temperature throughout the preparation. During heating, the PIBSA was purged with an inerting gas (CO₂) fed below the surface of the solution. When the solution reaches the temperature of 170° C., the purge gas was redirected to flow over the surface of the PIBSA solution. The flow of the blanketing gas was maintained throughout the preparation of the graft product.

The next step after the dissolution of the PIBSA was the grafting of 1-vinylimidazole (VIMA) onto the PIBSA. To carry out this segment of the preparation, two solutions were prepared, one containing about 40 grams (0.44 mole) of VIMA made up to about 60 milliliters with acetone and the other containing about 10 grams (0.068 mole) of DTBP made up to about 60 milliliters with heptane. These solutions were delivered simultaneously over a 60 minutes period using syringe pumps. The grafting reaction was then allowed to proceed for an additional 30 minutes beyond the 60 minutes allotted for the initiator feed. After the VIMA reaction was essentially complete a charge of about 17.6 grams (0.096 mole) of N-phenyl-1,4-phenylenediamine diluted in acetone was added quickly to the mixture. Reaction of the acyl groups on the PIBSA with the N-phenyl-1,4-phenylenediamine proceeded for 60 minutes thereby forming the low molecular weight Multifunctional Graft Polymer. The Infra red spectra of the product exhibited peaks associated with both the grafted VIMA and the condensation product generated from the amine and the anhydride.

### Example 8

### Preparation of Low Molecular Weight Multifunctional Graft Polymer

A 500 milliliter resin kettle equipped with an electric heating mantle, stirrer, thermometer, metering syringe pump feed system and a gas inlet was charged with a solution containing 25% by weight of 1300 MW polyisobutylene succinic anhydride (PIBSA) having a KVis of 1264.4 cSt at 100° C. The solution was prepared by dissolving 125 grams (0.096 mole) PIBSA, supplied by Dover Chemical Co. in 375 grams of FHR 100 base stock. The KVis of the solution was 12.5 cSt at 100° C.

The gas inlet permits the gas to be fed either below or above the surface of the solution. The solution is heated to 170° C. and maintained at temperature throughout the preparation. During heating, the PIBSA was purged with an inerting gas (CO₂) fed below the surface of the solution. When the solution reaches the temperature of 170° C., the purge gas was redirected to flow over the surface of the PIBSA solution. The flow of the blanketing gas was maintained throughout the preparation of the graft product.

The next step after the dissolution of the PIBSA was the grafting of 1-vinylimidazole (VIMA) onto the PIBSA. To carry out this segment of the preparation, two solutions were prepared, one containing about 38.8 grams (0.43 mole) of VIMA made up to 60 milliliters with acetone and the other containing about 9.7 grams (0.066 mole) of DTBP made up to about 60 milliliters with heptane. These solutions were delivered simultaneously over a 60 minutes period using syringe pumps. The grafting reaction was then allowed to proceed for an additional 30 minutes beyond the 60 minutes allotted for the initiator feed. The reaction product had a KVis of 21 cSt at 100° C. After the VIMA reaction was essentially complete a charge of about 17.6 grams (0.096 mole) of N-phenyl-1,4-phenylenediamine diluted in about 15 milliliters of acetone was added quickly to the mixture. Reaction of the acyl groups on the PIBSA with the N-phenyl-1,4-phenylenediamine proceeded for 60 minutes thereby forming the low molecular weight multifunctional graft polymer. The solution of the product had a KVis of 26.3 cSt at 100° C. The Infra red spectra of the product exhibited peaks associated with both the grafted VIMA and the condensation product generated from the amine and the anhydride.

We claim:

1. A multifunctional multiple graft monomer low molecular weight polymer comprising a graft low molecular weight polymer of:
(a) a least one low molecular weight polymer having graftable sites and a weight average molecular weight in the range of from about 500 to about 9950,
(b) at least one, ethylenically unsaturated, aliphatic or aromatic monomer having from 2 to about 50 carbon atoms and containing at least one of nitrogen and oxygen;
(c) at least one coupling agent selected from the group consisting of acylating agents and epoxides and having at least two component coupling sites; and
(d) at least one amine capable of reacting with the coupling group on the backbone of the aforesaid polymer that is formed by reaction between the coupling agent and the aforesaid polymer.

2. The multifunctional multiple graft monomer low molecular weight polymer of claim 1, wherein the low molecular weight polymer is selected from the group consisting of polyolefins, polyesters, mixed olefin-ester polymers, polystyrenes and mixtures thereof.

3. The multifunctional multiple graft monomer low molecular weight polymer of claim 2, which comprises at least one low molecular weight polymer produced from ethylene, propylene, isoprene, butane, butadiene, isobutylene, styrene, an alkyl methacryate, an alkyl acrylate, or combinations thereof.

4. The multifunctional multiple graft monomer low molecular weight polymer of claim 2, wherein the polymer is selected from the group consisting of homopolymers, copolymers and terpolymers.

5. The multifunctional multiple graft monomer low molecular weight polymer of claim 2, wherein the polymer is selected from the group consisting of polyethylene, polypropylene, ethylene-propylene copolymers, low molecular weight polymers containing two or more monomers, polyisobutene, polyalkylstyrenes, partially hydrogenated polyolefins of butadiene and styrene, and copolymers of isoprene, copolymers of styrene and isoprene, ethylene-propylene diene momoner polymers, and mixtures thereof.

6. The multifunctional multiple graft monomer low molecular weight polymer of claim 2, wherein the polymer is selected from the group consisting of polymers derived from alkylmethacrylates, alkylacrylates and mixtures thereof.

7. The multifunctional multiple graft monomer low molecular weight polymer of claim 2, wherein the polymer is selected from the group consisting of polymer derived from methyl methacrylate, methyl acrylate and mixtures thereof.

8. The multifunctional multiple graft monomer low molecular weight polymer of claim 1, wherein the polymer has a weight average molecular weight of from about 500 to about 6,500.

9. The multifunctional multiple graft monomer low molecular weight polymer of claim 8. wherein the polymer has a weight average molecular weight of from about 750 to about 5,000.

10. The multifunctional multiple graft monomer low molecular weight polymer of claim 9, wherein the polymer has a weight average molecular weight of from about 900 to about 5,000.

11. The multifunctional multiple graft polymer of claim 2, wherein said polymer has a polydispersity of from about 1 to about 20.

12. The multifunctional multiple graft polymer of claim 11, wherein said polymer has a polydispersity of from about 1 to about 15.

13. The multifunctional multiple graft monomer low molecular weight polymer of claim 1, wherein the ethylenically unsaturated monomer is selected from the group consisting of 1-vinylimidazole, 1-vinyl-2-pyrrolidinone, N-allylimidazole, 1-vinylpyrrolidinone, 2-vinylpyridine, 4-vinylpyridine, N-methyl-N-vinylacetamide, diallyl formamide, N-methyl-N-allyl formamide, N-ethyl-N-allyl formamide, N-cyclohexyl-N-allyl formamide, N-allyl diisooctyl phenothiazine, 2-methyl-1-vinylimidazole, 3-methyl-1-vinylpyrazole, N-vinylpurine, N-vinylpiperazines, vinylpiperidines, vinylmorpholines, and combinations thereof.

14. The multifunctional multiple graft monomer low molecular weight polymer of claim 13, wherein the ethylenically unsaturated monomer is selected from the group consisting of 1-vinylimidazole, 4-vinylpyridine, diallyl formamide, and mixtures thereof.

15. The multifunctional multiple graft monomer low molecular weight polymer of claim 14, wherein the ethylenically unsaturated monomer comprises 1-vinylimidazole.

16. The multifunctional multiple graft monomer low molecular weight polymer of claim 1 or 13, wherein the ethylenically unsaturated monomer comprises sulfur, phosphorous, halogen or combinations thereof.

17. The multifunctional multiple graft monomer low molecular weight polymer of claim 1, which contains from about 0.1 mole to about 9.9 moles of the ethylenically unsaturated monomer per mole of the polymer.

18. The multifunctional multiple graft monomer low molecular weight polymer of claim 17, which contains from about 1 mole to about 6 moles of the ethylenically unsaturated monomer per mole of the polymer.

19. The multifunctional multiple graft monomer low molecular weight polymer of claim 18, which has from about 1.5 moles to about 5.5 moles of the ethylenically unsaturated monomer per mole of the polymer.

20. The multifunctional multiple graft monomer low molecular weight polymer of claim 1, wherein the acylating agent is selected from the group consisting of monocarboxylic acids, dicarboxylic acids, polycarboxylic acids, anhydrides of such carboxylic acids, lower alkyl esters of such carboxylic acids, halides of such carboxylic acids, and combinations thereof.

21. The multifunctional multiple graft monomer low molecular weight polymer of claim 20, wherein the acylating agent is selected from the group consisting of monounsaturated C₄ to C₁₀ dicarboxylic acids, monounsaturated C₃ to C₁₀ monocarboxylic acids, the anhydrides thereof and mixtures of two or more of such acylating agents.

22. The multifunctional multiple graft monomer low molecular weight polymer of claim 21, wherein the acylating agent is selected from the group consisting of acrylic acid, crotonic acid, methalcrylic acid, maleic acid, maleic anhydride, fumaric acid, itaconic acid, itaconic anhydride, citraconic acid, citraconic anhydride, mesaconic acid, glutaconic acid, chloromaleic acid, aconitic acid, methylcrotonic acid, sorbic acid, 3-hexenoic acid, 10-decenoic acid, 2-pentene-1,3,5-tricarboxylic acid, cinnamic acid, lower alkyl esters thereof, and combinations thereof.

23. The multifunctional multiple graft monomer low molecular weight polymer of claim 1 which has from about 0.1 mole to about 9.9 moles of coupling agent per mole of polymer.

24. The multifunctional multiple graft monomer low molecular weight polymer of claim 23, which has from about 1 mole to about 6 moles of coupling agent per mole of polymer.

25. The multifunctional multiple graft monomer low molecular weight polymer of claim 24, which has from about 1.5 moles to about 5.5 moles of coupling agent per mole of polymer.

26. The multifunctional multiple graft monomer low molecular weight polymer of claim 1, wherein the mole ratio of the coupling agent to the ethylencially unsaturated monomer is from about 1:100 to 100:1.

27. The multifunctional multiple graft monomer low molecular weight polymer of claim 26, wherein the mole ratio of the coupling agent to the ethylencially unsaturated monomer is from about 1:20 to 20:1

28. The multifunctional multiple graft monomer low molecular weight polymer of claim 27, wherein the mole ratio of the coupling agent to the ethylencially unsaturated monomer is from about 1:10 to 10:1.

29. The multifunctional multiple graft monomer low molecular weight polymer of claim 28, wherein the mole ratio of said the coupling agent to the ethylencially unsaturated monomer is from about 1:2 to 2:1.

30. The multifunctional multiple graft monomer low molecular weight polymer of claim 29, wherein the mole ratio of said the coupling agent to the ethylencially unsaturated monomer is about 1:1.

31. The multifunctional multiple graft monomer low molecular weight polymer of claim 1, wherein the aforesaid amine is selected from the group consisting of primary amines and secondary amines.

32. The multifunctional multiple graft monomer low molecular weight polymer of claim 31, wherein the amine is selected from the group consisting of methyleneamines, ethyleneamines, butyleneamines, propyleneamines, pentyleneamines, hexyleneamines, heptyleneamines, octyleneamines, amino-alkyl-substituted piperazines, ethylene diamine, diethylene triamine, triethylene tetramine, propylene diamine, di(heptamethylene)triamine, tripropylene tetramine, tetraethylene pentamine, trimethylene diamine, pentaethylene hexamine, di(trimethylene)triamine, 3-mophoolinopropylamine, aniline, 4-morpholine aniline, benzylamine, phenylethylamine, 3-phenyl-1-propylamine, N-phenylphenylenediamines, N-phenyl-1,4-phenylendediamine, N-phenyl1,3-phenylenediamine, N-phenyl1,2-phenylenediamine, N-naphthyl-phenylenediamine, N-phenylnaphthalenediamine, N′-aminopropyl-N-phenylphenylenediamine, N,N-dimethylaminopropyl amine, N,N-dioctylenthyl amine, (2-aminopropyl)piperazine, 1-4-bis(2-aminoethyl)piperazine, 2-methyl-1-(2-aminobutyl)piperazine, N-arylphenylenediamines represented by the formula: 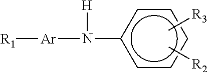
in which Ar is aromatic and R₁ is hydrogen, —NH-aryl, —NH-arylalkyl, —NH-alkylaryl, or a branched or straight chain radical having from 4 to 24 carbon atoms and the radical can be an alkyl, alkenyl, alkoxyl, arylalkyl, alkylaryl, hydroxyalkyl or aminoalkyl radical, R₂ is —NH₂, —(NH(CH₂)ₙ—)ₘ—NH₂, CH₂—(CH₂)ₙ—NH₂, -aryl-NH₂, in which n and m each has a value from 1 to 10, and R₃ is hydrogen or an alkyl, alkenyl, alkoxyl, arylalkyl, or alkylaryl radical, which may have from 4 to 24 carbon atoms; or by the formula: 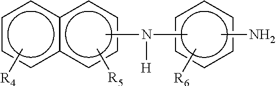
in which R₄, R₅ and R₆ are hydrogen or a linear or branched hydrocarbon radical containing from 1 to 10 carbon atoms and that radical may be an alkyl, alkenyl, alkoxyl, alkylaryl, arylalkyl, hydroxyalkyl, or aminoalkyl radical, and R₄, R₅ and R₆ can be the same or different; aminocarbazoles represented by the formula: 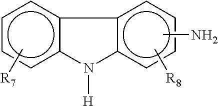
in which R₇ and R₈ represent hydrogen or an alkyl, alkenyl, or alkoxyl radical having from 1 to 14 carbon atoms, and R₇ and R₈ can be the same or different; aminoindoles represented by the formula: 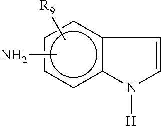
in which R₉ represents hydrogen or an alkyl radical having from 1 to 14 carbon atoms; amino-indazolinones represented by the formula: 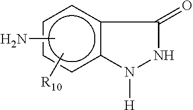
in which R₁₀ is hydrogen or an alkyl radical having from 1 to 14 carbon atoms; aminomercaptotriazole represented by the formula: 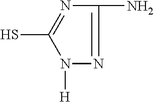
and aminoperimidines represented by the formula: 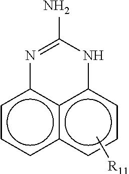
in which R₁₁ represents hydrogen or an alkyl or alkoxyl radical having from 1 to 14 carbon atoms; and combinations thereof.

33. The multifunctional multiple graft monomer low molecular weight polymer of claim 32, wherein said amine is N-phenyl-1,4-phenylenediamine.

34. The multifunctional multiple graft monomer low molecular weight polymer of claim 1, wherein the mole ratio of the amine to the coupling agent is about 1:10 to about 6:1.

35. The multifunctional multiple graft monomer low molecular weight polymer of claim 34 wherein the mole ratio of the amine to the coupling agent is about 1:3 to about 4:1.

36. The multifunctional multiple graft monomer low molecular weight polymer of claim 35 wherein the mole ratio for the amine to coupling agent is about 1:2 to about 2:1.

37. The multifunctional multiple graft monomer low molecular weight polymer of claim 1, wherein the total moles of ethylenically unsaturated monomer and reaction product of coupling agent and amine per mole of polymer are from about 0.5 mole up to about 20 moles.

38. The multifunctional multiple graft monomer low molecular weight polymer of claim 37 wherein the total moles of ethylenically unsaturated monomer and reaction product of coupling agent and amine per mole of polymer are from about 1 mole up to about 15 moles.

39. The multifunctional multiple graft monomer low molecular weight polymer of claim 39, wherein the total moles of ethylenically unsaturated monomer and reaction product of coupling agent and amine per mole of polymer are from about 2 moles up to about 11 moles.

40. The multifunctional multiple graft monomer low molecular weight polymer of claim 1 wherein the mole ratios of the reaction product of coupling agent and amine to the polymer and of the ethylenically unsaturated monomer to the polymer are each from about 0.1:1 to about 9.9:1.

41. A method of making a multifunctional multiple graft monomer low molecular weight polymer comprising:
(a) reacting an low molecular weight polymer having a weight average molecular weight in the range of from about 500 to about 9950 and an coupling agent in the presence of an initiator to form a graft reaction product having coupling groups on the backbone of the polymer available for reaction;
(b) reacting the graft reaction product formed in step (a) with an ethylenically unsaturated monomer in the presence of an initiator to form a graft reaction product of the ethylenically unsaturated monomer and the low molecular weight polymer; and
(c) reacting the graft product formed in step (b) with an amine capable of reacting with the coupling groups on the backbone of the polymer to form the multifunctional multiple graft monomer low molecular weight polymer.

42. The method of claim 41 wherein a mixture of the low molecular weight polymer and a high molecular weight polymer having a weight average molecular weight of from 10,000 to 750,000 are reacted with the aforesaid coupling agent in step (a) and the resulting graft reaction products are reacted in step (b) to form graft reaction products of the aforesaid ethylenically unsaturated monomer with the low molecular weight polymer and with the high molecular weight polymer, each of which is then reacted in step (c) with an amine that is capable of reacting with the coupling groups on the backbone of each such polymer.

43. A method of making a multifunctional multiple graft monomer low molecular weight polymer comprising:
(a) reacting in solution an low molecular weight polymer having a weight average molecular weight in the range of from about 500 to about 9950 and a coupling agent in the presence of an initiator to form a graft reaction product having coupling groups available for reaction;
(b) reacting in solution the graft reaction product formed in step (a) with an ethylenically unsaturated monomer in the presence of an initiator to form a graft reaction product of the ethylenicaly unsaturated monomer and the low molecular weight polymer; and
(c) reacting in solution the graft reaction product formed in step (b) with an amine capable of reacting with the coupling groups on the backbone of the polymer to form the multifunctional multiple graft monomer low molecular weight polymer.

44. The method of claim 43 wherein the reaction takes place in a solvent selected from Group I, Group II, Group III, Group IV and Group V base stocks and mixtures thereof.

45. The method of claim 43 wherein the solvent is selected from straight chain or branched aliphatic or alicyclic hydrocarbons, aromatic hydrocarbons, and mixtures thereof.

46. The method of claim 43 wherein the solvent is a hydrocracked base stock.

47. The method of claim 43 wherein the solvent is a Fischer Tropsch derived hydrocarbon base stock.

48. The method of claim 47, wherein the solvent is a base stock containing from about 0 to about 50 weight percent aromatic hydrocarbons.

49. The method of claim 48 wherein the solvent is a base stock containing from about 0 to about 25 weight percent aromatic hydrocarbons.

50. The method of claim 43, wherein the solvent is a polar organic or inorganic solvent.

51. The method of claim 43 wherein a mixture of the aforesaid low molecular weight polymer and a high molecular weight polymer having a weight average molecular weight of from 10,000 to 750,000 are reacted with an aforesaid coupling agent in step (a) and the resulting graft reaction products are reacted in step (b) to form graft reaction products of the aforesaid ethylenically unsaturated monomer with the low molecular weight polymer and with the high molecular weight polymer, each of which is then reacted in step (c) with an amine that is capable of reacting with the coupling groups on the backbone of each such polymer.

52. A method of making a multifunctional multiple graft monomer low molecular weight polymer comprising the steps of:
(a) reacting as a melt a low molecular weight polymer having a weight average molecular weight in the range of from about 500 to about 9950 and a coupling agent either thermally or in the presence of an initiator to form a graft reaction product having coupling groups available for reaction;
(b) reacting as a melt or in solution the graft reaction product formed in step (a) with an ethylenically unsaturated monomer either thermally or in the presence of an initiator to form a graft reaction product of the aforesaid ethylenicaly unsaturated monomer and the low molecular weight polymer; and
(c) reacting as a melt or in solution the graft reaction product formed in step (b) with an amine capable of reacting with the coupling groups on the backbone of the polymer to form an aforesaid multifunctional multiple graft monomer low molecular weight polymer.

53. The method of claim 52 wherein in step (a) the aforesaid low molecular weight polymer is first melted and then is mixed with the coupling agent and the initiator.

54. The method of claim 52 wherein a mixture of the aforesaid low molecular weight polymer and a high molecular weight polymer having a weight average molecular weight of from 10,000 to 750,000 are reacted with the aforesaid coupling agent in step (a) and the resulting graft reaction products are reacted in step (b) to form graft reaction products of the aforesaid ethylenically unsaturated monomer with the low molecular weight polymer and with the high molecular weight polymer, each of which is then reacted in step (c) with an amine that is capable of reacting with the coupling groups on the backbone of each such polymer.

55. A method of improving soot handling, viscosity, sludge and varnish control of a lubricating oil which comprises incorporating into the oil an effective amount of a multifunctional multiple graft monomer low molecular weight polymer of claim 1.

56. A lubricating oil comprising:
(a) a lubricant base oil;
(b) a least about 0.0005% to about 25% by weight of a multifunctional multiple graft monomer low molecular weight polymer of claim 1; and
(c) from 0% to about 25% by weight of other lubricating oil additives.

57. The lubricating oil of claim 56 comprising at least about 0.005% to about 20% by weight of a multifunctional multiple graft monomer low molecular weight polymer of claim 1.

58. A lubricating oil of claim 56 comprising at least about 0.05% to about 15% by weight of a multifunctional multiple graft monomer low molecular weight polymer of claim 1.

59. A lubricating oil concentrate comprising from about 0.05% to about 80% of a compound as claimed in claim 1.

60. A lubricating oil concentrate comprising from about 0.5% to about 50% of a compound as claimed in claim 1.

61. A fuel composition, comprising (a) a hydrocarbon based fuel optionally comprising alcohols and ethers; and (b) a multifunctional low molecular weight multi-graft polymer of claim 1 at a level in the range of from about 5 to about 5,000 ppm by weight.

62. The fuel composition of claim 61, comprising (a) a hydrocarbon based fuel optionally comprising alcohols and ethers; and (b) a multifunctional low molecular weight multi-graft polymer of claim 1 at a level in the range of from about 10 to about 5,000 ppm by weight.

63. The fuel composition of claim 62, comprising (a) a hydrocarbon based fuel optionally comprising alcohols and ethers; and (b) a multifunctional low molecular weight multi-graft polymer of claim 1 at a level in the range of from about 25 to about 1,500 ppm by weight.

64. The multifunctional multiple graft polymer of claim 11, wherein said polymer backbone has a polydispersity of from about 1 to about 5.

65. The multifunctional multiple graft monomer low molecular weight polymer of claim 1, wherein the ethylenically unsaturated monomer is selected form the group consisting of 4-methyl-5-vinylthiazole, N-allyl diisooctyl phenothiazine, 2-vinylthiobenzothiazole, 2-allylthiobenzothiazole, 2-butenylthiobenzothiazole, N-vinylphenothiazine, and N-allylphenothiazine.

66. The multifunctional multiple graft monomer low molecular weight polymer of claim 16, wherein the ethylenically unsaturated monomer comprises 4-methyl-5-vinyl thiazole.

67. The multifunctional multiple graft monomer low molecular weight polymer of claim 1 wherein the coupling agent has at least one of which is a site of olefinic unsaturation.

68. The multifunctional multiple graft monomer low molecular weight polymer of claim 1 wherein the mole ratios of the reaction product of coupling agent and amine to the polymer and of the ethylenically unsaturated monomer to the polymer are each from about 1:1 to about 9.9:1.

69. The multifunctional multiple graft monomer low molecular weight polymer of claim 1 wherein the mole ratios of the reaction product of coupling agent and amine to the polymer and of the ethylenically unsaturated monomer to the polymer are each from about 1:1 to about 6:1.

70. The multifunctional multiple graft monomer low molecular weight polymer of claim 1 wherein the mole ratios of the reaction product of coupling agent and amine to the polymer and of the ethylenically unsaturated monomer to the polymer are each from about 1:1 to about 5.5.

71. The multifunctional multiple graft monomer low molecular weight polymer of claim 1 wherein the mole ratios of the reaction product of coupling agent and amine to the polymer and of the ethylenically unsaturated monomer to the polymer are each from about 0.1:1 to about 6:1.

72. The multifunctional multiple graft monomer low molecular weight polymer of claim 1 wherein the low molecular weight polymer has a weight average molecular weight in the range of from about 500 to about 9500.

73. The method of claim 41, wherein the low molecular weight polymer has a weight average molecular weight in the range of from about 500 to about 9500.

74. The method of claim 43, wherein the low molecular weight polymer has a weight average molecular weight in the range of from about 500 to about 9500.

75. The method of claim 52, wherein the low molecular weight polymer has a weight average molecular weight in the range of from about 500 to about 9500.

76. The polymer made by the method of claim 42.

77. The polymer made by the method of claim 51.

78. The polymer made by the method of claim 54.

79. A multifunctional multiple graft monomer polymer comprising a graft polymer of:
(a) a mixture of least one low molecular weight polymer having graftable sites and a weight average molecular weight in the range of from about 500 to about 9950, and at least one high molecular weight polymer having graftable sites and having a weight average molecular weight polymer of from 10,000 to 750,000,
(b) at least one, ethylenically unsaturated, aliphatic or aromatic monomer having from 2 to about 50 carbon atoms and containing at least one of nitrogen and oxygen;
(c) at least one coupling agent selected from the group consisting of acylating agents and epoxides and having at least two component coupling sites; and
(d) at least one amine capable of reacting with the coupling group on the backbone of the aforesaid polymers that are formed by reaction between the coupling agent and the aforesaid polymers.
